(19) United States
(12) Patent Application Publication
(10) Pub. No.: US 2012/0057139 A1
(43) Pub. Date: Mar. 8, 2012

(54) Cleaning method, device manufacturing method, cleaning substrate, liquid immersion member, liquid immersion exposure apparatus, and dummy substrate

(75) Inventors: Akikazu TANIMOTO, Yokohama-shi (JP); Yutaka IKEDA, Kumagaya-shi (JP); Kenichi SHIRAISHI, Saitama-shi (JP); Ryo TANAKA, Saitama-City (JP); Shunji WATANABE, Tokyo (JP)

(73) Assignee: NIKON CORPORATION, TOKYO (JP)

(21) Appl. No.: 13/196,439

(22) Filed: Aug. 2, 2011

Related U.S. Application Data
(60) Provisional application No. 61/385,326, filed on Sep. 22, 2010.

(30) Foreign Application Priority Data
Aug. 4, 2010 (JP) P2010-175810

(51) Int. Cl. G03B 27/58; B08B 1/00; B08B 3/04

(52) U.S. Cl. 355/30; 355/77; 355/72; 134/1; 15/104.93

(57) ABSTRACT

A cleaning substrate and a liquid immersion member face each other in order to clean the liquid immersion member. The cleaning substrate has a first liquid-repellent portion which is liquid-repellent to a first cleaning liquid for cleaning and a lyophilic portion which is disposed in at least a part of the periphery of the first liquid-repellent portion and is more lyophilic than the first liquid-repellent portion.

### CROSS-REFERENCE TO RELATED APPLICATION

This application is a non-provisional application claiming priority to and the benefit of U.S. provisional application No. 61/385,326, filed on Sep. 22, 2010. This application is also claiming priority to and the benefit of Japanese Patent Application No. 2010-175810, filed on Aug. 4, 2010. The entire contents of which are incorporated herein by reference.

### BACKGROUND

1. Field of the Invention

The present invention relates to a cleaning method, a device manufacturing method, a cleaning substrate, a liquid immersion member, a liquid immersion exposure apparatus, and a dummy substrate.

2. Description of Related Art

In a manufacturing process of a micro device such as a semiconductor device, an exposure apparatus is used which exposes a substrate with exposure light. If a member or part of the exposure apparatus is contaminated, exposure may be poor so that a defect occurs in a pattern formed on a substrate, for example, which may consequently result in a defective device. Thus, techniques which clean a predetermined member in the exposure apparatus have been proposed, as disclosed in U.S. Unexamined Patent Application Publication No. 2008/0273181, U.S. Unexamined Patent Application Publication No. 2009/0195761, for example.

### SUMMARY

It is effective to clean a member in an exposure apparatus to suppress the occurrence of poor exposure.

It is an object of the aspects of the present invention to provide a cleaning method and a cleaning substrate which can suppress the occurrence of poor exposure. It is another object of the aspects of the present invention to provide a liquid immersion member and a liquid immersion exposure apparatus which can suppress the occurrence of poor exposure. It is still another object of the aspects of the present invention to provide a device manufacturing method which can suppress the occurrence of a defective device. It is yet still another object of the aspects of the present invention to provide a dummy substrate which can suppress the occurrence of poor exposure.

According to a first embodiment of the present invention, there is provided a method of cleaning a liquid immersion member which has an opening through which exposure light irradiating a substrate passes and holds a first liquid between the liquid immersion member and the substrate so that at least a part of an optical path of the exposure light is filled with the first liquid, in a liquid immersion exposure apparatus, the method including: allowing an object which includes a first portion which is liquid-repellent to a second liquid for cleaning and a second portion which is disposed in at least a part of the periphery of the first portion and is more lyophilic to the second liquid than the first portion and the liquid immersion member to face each other; supplying the second liquid between the liquid immersion member and the second portion of the object; and cleaning the liquid immersion member with the second liquid while suppressing the second liquid supplied between the liquid immersion member and the second portion from passing through the opening using the first portion of the object.

According to a second embodiment of the present invention, there is provided a device manufacturing method including: cleaning the liquid immersion member using the cleaning method according to the first embodiment; holding the first liquid between the cleaned liquid immersion member and a substrate; exposing the substrate with exposure light through the first liquid; and developing the exposed substrate.

According to a third embodiment of the present invention, there is provided a cleaning substrate which is used for cleaning a liquid immersion member which has an opening through which exposure light irradiating a substrate passes and a liquid recovery port which is disposed in at least a part of the periphery of the opening, and holds a first liquid between the liquid immersion member and the substrate so that at least a part of an optical path of the exposure light is filled with the first liquid, in a liquid immersion exposure apparatus, the cleaning substrate including: a first portion which is liquid-repellent to a second liquid for cleaning; and a second portion which is disposed in at least a part of the periphery of the first portion and is more lyophilic to the second liquid than the first portion, wherein when the cleaning substrate is disposed to face the liquid immersion member so as to clean the liquid immersion member with the second liquid, the first portion suppresses the second liquid supplied between the liquid immersion member and the second portion from passing through the opening.

According to a fourth embodiment of the present invention, there is provided a liquid immersion member which is used in a liquid immersion exposure apparatus which exposes a substrate with exposure light through a first liquid, and holds the first liquid between the liquid immersion member and the substrate so that at least a part of an optical path of the exposure light is filled with the first liquid, the liquid immersion member including: an opening through which the exposure light passes; a liquid recovery port which is disposed in at least a part of the periphery of the opening; and a supply port which is disposed outside of the liquid recovery port with reference to the opening and through which a second liquid for cleaning is supplied.

According to a fifth embodiment of the present invention, there is provided a liquid immersion exposure apparatus which exposes a substrate with exposure light through a first liquid, the apparatus including the liquid immersion member according to the fourth embodiment.

According to a sixth embodiment of the present invention, there is provided a device manufacturing method including: exposing a substrate using the liquid immersion exposure apparatus according to the fifth embodiment; and developing the exposed substrate.

According to a seventh embodiment of the present invention, there is provided a dummy substrate which is used for a non-exposure operation of a liquid immersion exposure apparatus which exposes a substrate with exposure light through a liquid, which is different from an exposure operation of exposing the substrate, the dummy substrate including a notch associated with the non-exposure operation in an outer periphery portion thereof.

According to the embodiments of the present invention, it is possible to suppress the occurrence of poor exposure. Further, according to the embodiments of the present invention, it is possible to suppress the occurrence of a defective device.

### BRIEF DESCRIPTION OF THE DRAWINGS

FIG. 1 is a diagram illustrating an example of exposure apparatus according to a first embodiment.

FIG. 2A is a diagram illustrating an example of a liquid immersion member according to the first embodiment.

FIG. 2B is a diagram illustrating an example of the liquid immersion member according to the first embodiment.

FIG. 3 is a diagram illustrating an example of the liquid immersion member according to the first embodiment.

FIG. 4 is a diagram illustrating an example of a liquid supply system according to the first embodiment.

FIG. 5A is a diagram illustrating an example of a cleaning substrate according to a second embodiment.

FIG. 5B is a diagram illustrating an example of the cleaning substrate according to the second embodiment.

FIG. 6A is a diagram illustrating another example of the cleaning substrate according to the second embodiment.

FIG. 6B is a diagram illustrating another example of the cleaning substrate according to the second embodiment.

FIG. 7 is a diagram illustrating an example of a cleaning method according to a third embodiment.

FIG. 8A is a diagram illustrating an example of the cleaning method according to the third embodiment.

FIG. 8B is a diagram illustrating an example of the cleaning method according to the third embodiment.

FIG. 8C is a diagram illustrating an example of the cleaning method according to the third embodiment.

FIG. 9A is a diagram illustrating an example of the cleaning method according to the third embodiment.

FIG. 9B is a diagram illustrating an example of the cleaning method according to the third embodiment.

FIG. 9C is a diagram illustrating an example of the cleaning method according to the third embodiment.

FIG. 10A is a diagram illustrating an example of the cleaning method according to the third embodiment.

FIG. 10B is a diagram illustrating an example of the cleaning method according to the third embodiment.

FIG. 10C is a diagram illustrating an example of the cleaning method according to the third embodiment.

FIG. 11 is a diagram illustrating an example of a cleaning method according to a fourth embodiment.

FIG. 12 is a diagram illustrating an example of a cleaning method according to a fifth embodiment.

FIG. 13 is a diagram illustrating an example of a device manufacturing method.

### DESCRIPTION OF EMBODIMENTS

Hereinafter, embodiments of the present invention will be described with reference to the accompanying drawings, which do not limit the present invention. In this description, an XYZ orthogonal coordinate system is set, and the positional relationship of respective components will be described with reference to the XYZ orthogonal coordinate system. A predetermined direction in the horizontal plane is represented as an X axis direction, a direction which is orthogonal to the X axis direction in the horizontal plane is represented as a Y axis direction, and a direction (that is, vertical direction) which is orthogonal to both of the X axis direction and the Y axis direction is represented as a Z axis direction. Further, the rotational directions (tilting directions) around the X, Y and Z axes are respectively represented as θX, θY and θZ directions.

### First Embodiment

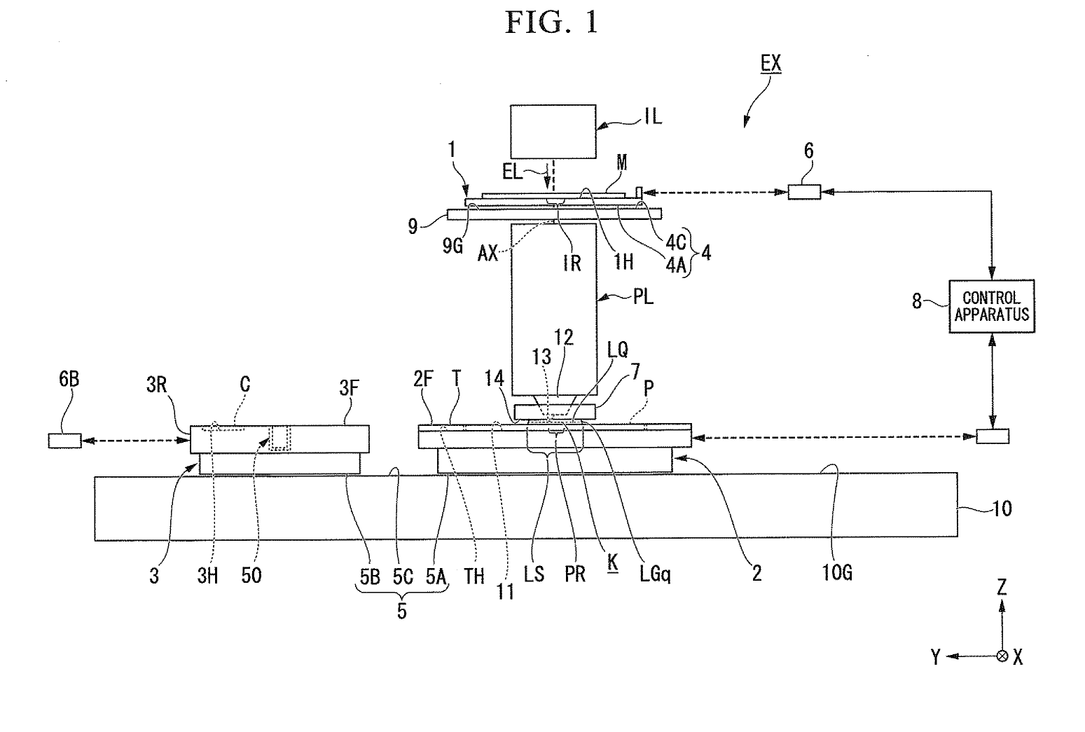

A first embodiment will be described. FIG. 1 is a schematic configuration diagram illustrating an example of an exposure apparatus EX according to the present embodiment. The exposure apparatus EX according to the present embodiment is a liquid immersion exposure apparatus which exposes a substrate P with exposure light EL using an exposure liquid LQ. In the present embodiment, a liquid immersion space LS is formed so that at least a part of an optical path of the exposure light EL is filled with the exposure liquid LQ. The immersion space is a portion (a space or a region) in which liquid is filled. The substrate P is exposed with the exposure light EL through the exposure liquid LQ in the liquid immersion space LS. In the present embodiment, water (pure water) is used as the exposure liquid LQ.

Further, the exposure apparatus EX according to the present embodiment is, for example, an exposure apparatus including a substrate stage and a measurement stage as disclosed in U.S. Pat. No. 6,897,963, Europe Unexamined Patent Application Publication No. 1,713,113, or the like.

In FIG. 1, the exposure apparatus EX includes a movable mask stage 1 which holds a mask M, a movable substrate stage 2 which holds the substrate P, and a movable measurement stage 3 on which a measurement member C (measurer) which measures the exposure light EL without holding the substrate P is mounted, an illumination system IL which illuminates the mask M with the exposure light EL, a projection optical system PL which projects an image of a pattern of the mask M, which is illuminated with the exposure light EL, to the substrate P, a liquid immersion member 7 which forms the liquid immersion space LS so that an optical path K of the exposure light EL emitted from the projection optical system PL is filled with the exposure liquid LQ, and a control device 8 which controls the operation of the entire exposure apparatus EX.

The mask M includes a reticle on which a device pattern to be projected to the substrate P is formed. The mask M includes a transmissive mask which includes a transparent plate, such as a glass plate, and the pattern, which is formed on the transparent plate using a shielding material such as chrome. A reflective mask may be used as the mask M.

The substrate P is a substrate used for manufacturing devices. A device pattern can be formed on the substrate P. The substrate P includes a base material, such as a semiconductor wafer, and a photosensitive film, which is formed on the base material, for example. The photosensitive film is made of a photosensitive material (photoresist). Further, the substrate P may include a separate film in addition to the photosensitive film. For example, the substrate P may include an antireflection film or a protection film (a top coat film) which protects the photosensitive film.

The illumination system IL irradiates a predetermined illumination region IR with the exposure light EL. The illumination region IR includes a position which is capable of being irradiated with the exposure light EL emitted from the illumination system IL. As the exposure light EL emitted from the illumination system IL, for example, deep ultraviolet light (DUV light), such as a bright line (g-line, h-line, or i-line) emitted from, for example, a mercury lamp and KrF excimer laser light (with a wavelength of 248 nm), and vacuum ultraviolet light (VUV light), such as ArF excimer light (with a wavelength of 193 nm) and F₂ laser light (with a wavelength of 157 nm), or the like may be used. In the present embodiment, as the exposure light EL emitted from the illumination system IL, the ArF excimer laser light is used.

The mask stage 1 is capable of moving on a guide surface 9G of a base member 9. The mask stage 1 includes a mask holding section 1H which is capable of holding the mask M to be released. In a state where the mask M is held by the mask holding section 1H, the mask stage 1 is capable of moving in a position where the mask M can be irradiated with the exposure light EL emitted from the illumination system IL.

The projection optical system PL irradiates a predetermined projection region PR with the exposure light EL. The projection optical system PL includes an emitting surface 13 which emits the exposure light EL toward an image plane of the projection optical system PL. Among a plurality of optical devices of the projection optical system PL, a terminal optical device 12 which is the closest to the image plane of the projection optical system PL includes the emitting surface 13. The projection region PR includes a position which can be irradiated with the exposure light EL emitted from the emitting surface 13. The projection optical system PL projects the image of the pattern of the mask M to at least a part of the substrate P, which is disposed in the projection region PR, with a predetermined projection magnification. The projection optical system PL in the present embodiment is a reduction system which has a projection magnification of, for example, ¼, ⅕ or ⅛. The projection optical system PL may be a unity magnification system or an enlargement system. In the present embodiment, an optical axis AX of the projection optical system PL is parallel to the Z axis. In the present embodiment, the exposure light EL emitted from the emitting surface 13 travels in a −Z direction. The projection optical system PL may form either an inverted image or an erected image.

The substrate stage 2 and the measurement stage 3 are capable of moving on a guide surface 10G of a base member 10. The substrate stage 2 includes a substrate holding section 11 which holds the substrate P to be released. In a state where the substrate P is held by the substrate holding section 11, the substrate stage 2 is capable of moving to a position which can be irradiated with the exposure light EL emitted from the projection optical system PL.

The measurement stage 3 includes a holding section 3H which supports a measurement member C to be released. In a state where the measurement member C is held by the holding section 3H, the measurement stage 3 is capable of moving to a position which can be irradiated with the exposure light EL emitted from the projection optical system PL.

The substrate stage 2 includes a holding section TH which is disposed in at least a part of the periphery of the substrate holding section 11 as disclosed in, for example, U.S. Unexamined Patent Application Publication No. 2007/0177125, U.S. Unexamined Patent Application Publication No. 2008/0049209, or the like, and holds a cover member T to be released. The cover member T is disposed around the substrate P held by the substrate holding section 11. An upper surface of the substrate holding section 11 which directs to the +Z direction may be exposed in the periphery of the substrate P held by the substrate holding section 11, without using the releasable cover member T. In this case, the liquid immersion space LS may be formed at least in a part of the upper surface of the substrate holding section 11.

The measurement member C mounted on the measurement stage 3 may be, for example, a member which forms a part of a spatial image measurement system as disclosed in U.S. Unexamined Patent Application Publication No. 2002/0041377 or the like, may be a member which forms a part of a luminance unevenness measurement system as disclosed in U.S. Pat. No. 4,465,368 or the like, may be a standard member as disclosed in U.S. Pat. No. 5,493,403 or the like, may be a member which forms a part of an irradiance measurement system as disclosed in U.S. Unexamined Patent Application Publication No. 2002/0061469 or the like, or may be a member which forms a part of a wavefront aberration measurement system as disclosed in Europe Patent No. 1,079,223 or the like.

The mask stage 1 is capable of moving by the operation of a drive system 4. The drive system 4 includes a planar motor having a slider 4A disposed on the mask stage 1 and a stator 4C disposed in the base member 9. The mask stage 1 is capable of moving on the guide surface 9G, by the operation of the drive system 4, in six directions of the X axis, Y axis, Z axis, θX, θY and θZ directions.

Each of the substrate stage 2 and the measurement stage 3 is capable of moving by the operation of a drive system 5. The drive system 5 includes a planar motor having a slider 5A disposed on the substrate stage 2, a slider 5B disposed on the measurement stage 3, and a stator 5C disposed on the base member 10. Each of the substrate stage 2 and the measurement stage 3 is capable of moving on the guide surface 10G, by the operation of the drive system 5, in six directions of the X axis, Y axis, Z axis, θX, θY and θZ directions. An example of the planar motor is disclosed in the U.S. Pat. No. 6,452,292, for example.

The drive system 4 may include a linear motor, for example. The drive system 5 may also include a linear motor, for example.

The positions of the mask stage 1, the substrate stage 2 and the measurement stage 3 are measured by an interferometer system 6. When an exposure process of the substrate P is performed, or when a predetermined measurement process is performed, the control device 8 operates the drive systems 4 and 5 on the basis of the measurement results of the interferometer system 6, and controls the positions of the mask stage 1 (mask M), the substrate stage 2 (substrate P) and the measurement stage 3 (measurement member C).

In the present embodiment, each of an upper surface 2F of the substrate stage 2 and an upper surface 3F of the measurement stage 3 has a liquid-repellent property to the exposure liquid LQ. The upper surface 2F in the present embodiment includes an upper surface of the cover member T. The upper surfaces 2F and 3F direct to the +Z direction, and are capable of facing the terminal optical device 12 and the liquid immersion member 7. The upper surfaces 2F and 3F in the present embodiment are formed of a film of material including fluorine.

The liquid immersion member 7 is capable of forming the liquid immersion space LS so that the optical path K of the exposure light EL emitted from the emitting surface 13 is filled with the exposure liquid LQ. The liquid immersion member 7 is disposed in the vicinity of the terminal optical device 12. The liquid immersion member 7 in the present embodiment has an annular shape. At least a part of the liquid immersion member 7 in the present embodiment is disposed around the terminal optical device 12. Further, at least a part of the liquid immersion member 7 in the present embodiment is disposed around the optical path K of the exposure light EL emitted from the emitting surface 13.

The liquid immersion member 7 may be disposed in at least a part of the periphery of the terminal optical device 12, and may not be disposed around the optical path K of the exposure light EL emitted from the emitting surface 13. Further, the liquid immersion member 7 may be disposed in at least a part of the periphery of the optical path K of the exposure light EL emitted from the emitting surface 13, and may not be disposed around the terminal optical device 12. Further, the plurality of liquid immersion members may be disposed at intervals around the optical path of the exposure light EL.

The liquid immersion member 7 includes a lower surface 14 which can face an object disposed in a position (projection region PR) which can be irradiated with the exposure light EL emitted from the terminal optical device 12. The liquid immersion member 7 holds the exposure light EL between the liquid immersion member 7 and the object to form the liquid immersion space LS so that at least a part of the optical path K of the exposure light EL emitted from the emitting surface 13 is filled with the exposure liquid LQ. As the exposure liquid LQ is held between the emitting surface 13 and the lower surface 14 on one side and the surface (upper surface) of the object on the other side, the liquid immersion space LS is formed so that the optical path K of the exposure light EL between the terminal optical device 12 and the object is filled with the exposure liquid LQ.

In the present embodiment, the object which can be disposed in the projection region PR includes an object which is movable on the side of an image plane of the projection optical system PL (the side of the emitting surface 13 of the terminal optical device 12). In the present embodiment, the object includes at least one of the substrate stage 2, the substrate P held by the substrate stage 2, a cleaning substrate CP (which will be described later), a dummy substrate (which will be described later), the measurement stage 3, and the measurement member C mounted on the measurement stage 3.

For example, when the substrate P is exposed, at least a part of the surface of the substrate P faces the emitting surface 13 and the lower surface 14. The terminal optical device 12 and the liquid immersion member 7 are capable of holding the exposure liquid LQ between the terminal optical device 12 and the liquid immersion member 7 and the object disposed in the projection region PR. In the exposure of the substrate P, the liquid immersion member 7 holds the exposure liquid LQ between the liquid immersion member 7 and the substrate P so that at least a part of the optical path K of the exposure light EL which irradiates the substrate P is filled with the exposure liquid LQ. In the exposure of the substrate P, at least a part of the emitting surface 13 and the lower surface 14 is in contact with the exposure liquid LQ.

In the present embodiment, when the substrate P is irradiated with the exposure light EL, the liquid immersion space LS is formed so that a partial region of the surface of the substrate P including the projection region PR is covered with the exposure liquid LQ. The liquid immersion member 7 holds the exposure liquid LQ in a local region which is smaller than the substrate P. At least a part of an interface (meniscus, edge) LGq of the exposure liquid LQ is formed between the lower surface 14 of the liquid immersion member 7 and the surface of the substrate P. That is, the exposure apparatus EX according to the present embodiment adopts a local liquid immersion method.

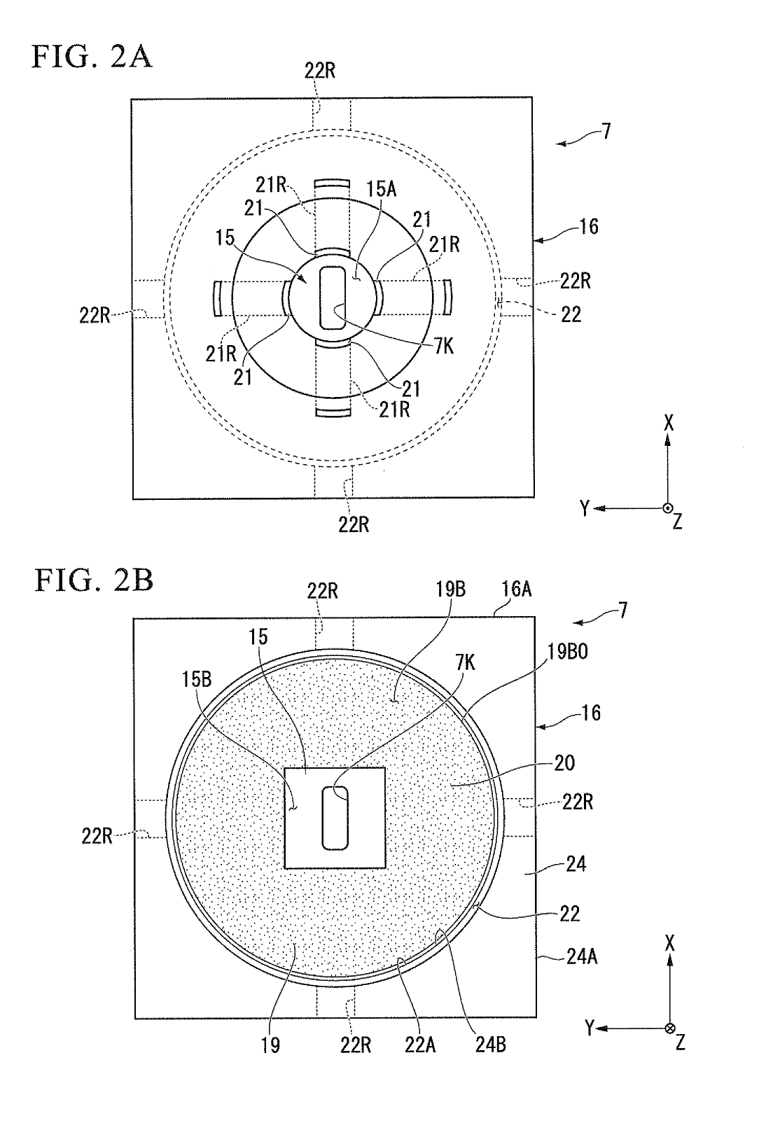

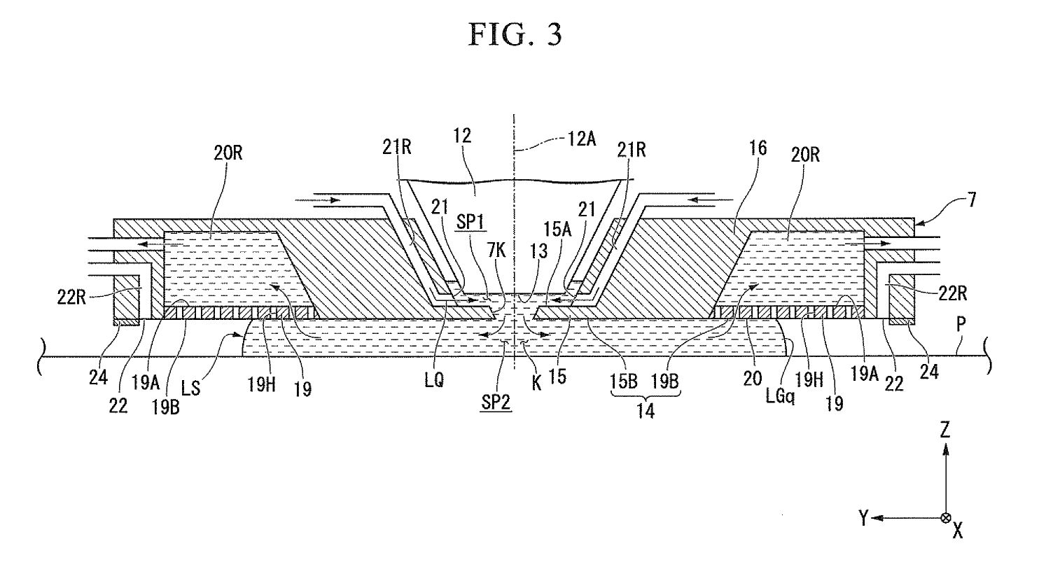

FIG. 2A is a diagram illustrating the liquid immersion member 7 according to the present embodiment, when seen from the upper side thereof (+Z side), and FIG. 2B is a diagram thereof, when seen from the lower side thereof (−Z side). FIG. 3 is a cross-sectional view which is parallel to the YZ plane indicating the liquid immersion member 7 in the present embodiment. FIG. 3 shows a case where the substrate P is disposed in a position which faces the terminal optical device 12 and the liquid immersion member 7, but as described above, for example, a different object such as the substrate stage 2 and the measurement stage 3 may be disposed.

The liquid immersion member 7 includes a plate section 15 and a main body section 16. In the present embodiment, the appearance of the liquid immersion member 7 (main body section 16) is rectangular. The appearance of the main body section 16 is not limited to the rectangular shape. The shape of the appearance of the main body section 16 may be any one of a circular shape, an elliptical shape, a polygonal shape, a shape in which some corners of the polygonal shape are rounded, a shape having an outline of a free curve, a combined shape of these shapes. For example, the appearance of the liquid immersion member 7 (main body section 16) may be a circular shape like the appearance of a second supply port 22 which will be described later.

The plate section 15 is disposed around the optical path K of the exposure light EL emitted from the emitting surface 13. At least a part of the main body section 16 is disposed around the terminal optical device 12. The plate section 15 includes a lower surface 15B which can face the surface of the substrate P and an upper surface 15A which directs to an opposite direction of the lower surface 15B. At least a part of the upper surface 15A faces the emitting surface 13. In the present embodiment, the appearance of the lower surface 15B of the plate section 15 is rectangular. The appearance of the lower section 15B is not limited to the rectangular shape. The appearance shape of the lower surface 15B may be any one of a circular shape, an elliptical shape, a polygonal shape, a shape in which some corners of the polygonal shape are rounded, a shape having an outline of a free curve, a combined shape of these shapes.

The liquid immersion member 7 includes an opening (path) 7K through which the exposure light EL emitted from the emitting surface 13 can pass. The exposure light EL which is emitted from the emitting surface 13 and irradiates the substrate P passes through the opening 7K. The opening 7K is formed in the plate section 15. The opening 7K is formed to connect the upper surface 15A and the lower surface 15B. The lower surface 15B is disposed around a lower end of the opening 7K. The upper surface 15A is disposed around an upper end of the opening 7K. The exposure light EL emitted from the emitting surface 13 can pass through the opening 7K and can irradiate the substrate P.

In the present embodiment, a traveling direction of the exposure light EL emitted from the emitting surface 13 is parallel to an optical axis 12A of the terminal optical direction 12. The optical axis 12A in the present embodiment is parallel to the Z axis.

In the present embodiment, the size of the opening 7K in the Y axis direction is smaller than the size of the opening 7K in the X axis direction. The opening 7K in the present embodiment is rectangular. The shape of the opening 7K may be any one of an elliptical shape, a circular shape, a polygonal shape, a shape in which some corners of the polygonal shape are rounded, a shape having an outline of a free curve, a combined shape of these shapes.

The liquid immersion member 7 includes a first supply port 21 through which the exposure liquid LQ can be supplied, and a liquid recovery port 20 through which the exposure liquid LQ can be recovered. In at least the exposure of the substrate P, the exposure liquid LQ is supplied through the first supply port 21, and at least a part of the exposure liquid LQ supplied from the first supply port 21 is recovered through the liquid recovery port 20. In the exposure of the substrate P, the substrate P is disposed to face the liquid immersion member 7. In a state where the substrate P is disposed to face the liquid immersion member 7, the exposure liquid LQ is supplied through the first supply port 21.

Further, the liquid immersion member 7 in the present embodiment includes a second supply port 22 which is different from the first supply port 21. Through the second supply port 22, a liquid which is different from the exposure liquid LQ can be supplied. Through the second supply port 22 in the present embodiment, a cleaning liquid LC used for cleaning at least a part of the liquid immersion member 7 can be supplied. The cleaning liquid LC used for cleaning may be one type, or two or more types. In the following description, one type or two or more types of cleaning liquid are simply referred to as a cleaning liquid LC. In the present embodiment, as the cleaning liquid LC, a first cleaning liquid LC1 and a second cleaning liquid LC2 are used.

The liquid immersion member 7 includes a first interior liquid passage 21R connected to the first supply port 21, a second interior liquid passage 22R connected to the second supply port 22, and a third interior liquid passage 20R connected to the liquid recovery port 20. The first interior liquid passage 21R, the second interior liquid passage 22R and the third interior liquid passage 20R are respectively formed in the liquid immersion member 7. The first supply port 21 is formed at one end of the first interior liquid passage 21R. The second supply port 22 is formed at one end of the second interior liquid passage 22R. The liquid recovery port 20 is formed at one end of the third interior liquid passage 20R.

The first supply port 21 in the present embodiment is disposed to face the optical path K in the vicinity of the optical path K of the exposure light EL. In the present embodiment, the plurality of first supply ports 21 is disposed. The first supply ports 21 in the present embodiment are respectively disposed on the +X side, −X side, +Y side and −Y side with reference to the optical path K. Through the first supply port 21 in the present embodiment, the exposure liquid LQ is supplied to a space SP1 between the emitting surface 13 and the upper surface 15A. The exposure liquid LQ supplied through the first supply port 21 flows through the space SP1 and then flows to a space SP2 between the lower surface 15B (lower surface 14) and the surface (upper surface of the object) of the substrate P through the opening 7K. The position of the first supply port 21 is not limited to the above mentioned position. Further, the number of the first supply ports 21 is not limited to four, but may be one.

Through the liquid recovery port 20, at least a part of the exposure liquid LQ on the substrate P (object) can be recovered. The liquid recovery port 20 is disposed in a predetermined position of the liquid immersion member 7 which can face the surface of the substrate P. The liquid recovery port 20 according to the present embodiment is disposed in at least a part of the periphery of the opening 7K. In the present embodiment, the lower surface 15B is disposed around the opening 7K, and the liquid recovery port 20 is disposed in at least a part of the periphery of the lower surface 15B. The liquid recovery port 20 in the present embodiment has an annular shape in the XY plane, and is disposed around the lower surface 15B. The plurality of liquid recovery ports 20 may be disposed to surround the lower surface 15B at a predetermined interval.

In the present embodiment, a porous member 19 is disposed in the liquid recovery port 20. The porous member 19 has a plurality of holes (openings or pores). The porous member 19 in the present embodiment is a plate shaped member. The porous member 19 in the present embodiment includes a lower surface 19B which can face the surface of the substrate P and an upper surface 19A which directs to an opposite direction of the lower surface 19B. The holes 19H of the porous member 19 are formed to connect the upper surface 19A and the lower surface 19B. The porous member 19 has the plurality of holes 19H.

In the present embodiment, the lower surface 19B is parallel to the XY plane, but at least a part of the lower surface 19B may be tilted with respect to the XY plane. Further, at least a part of the lower surface 19B may include a curve. Further, a step difference may be formed in a part of the lower surface 19B. For example, a first region of the lower surface 19B disposed around the lower surface 15B (opening 7K) may be disposed in a first position in the Z axis direction, and a second region of the lower surface 19B disposed around the first region may be disposed in a second position which is higher than the first position. The second region of the lower surface 19B may be disposed on a position which is lower than the first region.

In the present embodiment, the lower surface 15B and the lower surface 19B are disposed in the same positions in the Z axis direction, but may be disposed in different positions. For example, the lower surface 19B may be disposed in a position (+Z side position which is distant from the substrate P) which is higher than the lower surface 15B. The lower surface 19B may be disposed in a position (−Z side position which is close to the substrate P) which is lower than the lower surface 15B.

In the present embodiment, the lower surface 19B of the porous member 19 is disposed around the lower surface 15B of the plate section 15. In the present embodiment, the lower surface 14 of the liquid immersion member 7 which can face the surface of the substrate P (upper surface of the object) includes the lower surface 15B of the plate section 15 and the lower surface 19B of the porous member 19. In the present embodiment, the lower surface 14 which includes the lower surface 15B and the lower surface 19B is disposed around the opening 7K.

A mesh filter which is a porous member which is formed with a plurality of small holes and has a network shape may be disposed in the liquid recovery port 20. Further, the porous member 19 may not be disposed in the liquid recovery port 20. Further, in the present embodiment, an outer periphery (appearance) 19BO of the lower surface 19B is a circular shape, but is not limited to the circular shape. The shape of the lower surface 19B may be any one of a rectangular shape, an elliptical shape, a polygonal shape, a shape in which some corners of the polygonal shape are rounded, a shape having an outline of a free curve, a combined shape of these shapes. The liquid recovery port may employ the holes 19H of the porous member 19.

Further, the porous member 19 may not be disposed in the liquid recovery port 20.

In the present embodiment, the exposure liquid LQ (exposure liquid LQ on the object) in the space SP2 is recovered through the holes 19H of the porous member 19. In the exposure of the substrate P, when the exposure liquid LQ on the substrate P is recovered, the control device 8 adjusts (generates a pressure difference) the pressure of the space SP2 which faces the lower surface 19B and the pressure of a space (third interior liquid passage 20R) which faces the upper surface 19A to be different from each other. Thus, the exposure liquid LQ on the substrate P is recovered through the holes 19H of the porous member 19.

The control device 8 in the present embodiment performs the supply operation of the exposure liquid LQ through the first supply port 21 and the recovery operation of the exposure liquid LQ through the liquid recovery port 20 (holes 19H), in the exposure of the substrate P, to thereby form the liquid immersion space LS with the exposure liquid LQ between the terminal optical device 12 and the liquid immersion member 7 on one side and the substrate P (object) on the other side.

At least a part of the liquid immersion member 7 in the present embodiment is formed of a material including metal. In the present embodiment, at least a part of the liquid immersion member 7 is formed of a material including titanium. The material including titanium includes at least one of titanium and titanium alloy. The plate section 15 and the main body section 16 in the present embodiment are formed of a material including titanium. In the present embodiment, the porous member 19 is formed of a material including titanium.

At least a part of the liquid immersion member 7 may be formed of a material including a material which is different from titanium, for example, of a material including stainless steel, magnesium or the like. At least a part of the liquid immersion member 7 may be formed of a material including ceramics. Further, at least a part of the surface of the liquid immersion member 7 may be formed of amorphous carbon. The amorphous carbon includes tetrahedral amorphous carbon. For example, in a case where at least a part of the upper surface 15A and the lower surface 15B of the plate section 15 is formed of amorphous carbon, the plate section 15 (base material) made of a material including titanium is formed, and a film of amorphous carbon is formed so that at least a part of the surface of the base material is covered by the amorphous carbon film. Thus, at least a part of the upper surface 15A and the lower surface 15B is formed of amorphous carbon. Further, at least a part of the upper surface 19A, the lower surface 19B and the interior surface of the holes 19H in the porous member 19 may be formed of amorphous carbon. For example, the amorphous carbon film can be formed on the base material using a CVD method or a PVD method.

Further, at least a part of the surface of the liquid immersion member 7 may be formed of an oxide film. At least a part of the upper surface 19A, the lower surface 19B and the interior surface of the holes 19H in the porous member 19 may be formed of an oxide film. The oxide films may be titanium oxide films, for example.

The second supply port 22 is disposed outside the liquid recovery port 20 (hole 19H) with reference to the opening 7K. The second supply port 22 is disposed outside the liquid recovery port 20 with reference to the optical axis 12A (optical path K).

The second supply port 22 in the present embodiment is disposed in the same position (height) as the lower surface 15B of the liquid immersion member 7 in the Z axis direction. The second supply port 22 and the lower surface 15B may be disposed in different positions in the Z axis direction. For example, the second supply port 22 may be disposed in a position (+Z side position which is distant from the substrate P) which is higher than the lower surface 15B. Contrarily, the second supply port 22 may be disposed in a position (−Z side position which is close to the substrate P) which is lower than the lower surface 15B.

In the following description, in a case where an object N is present, for example, between an object M and the optical axis 12A in a plane parallel to the XY plane, the object M may be disposed outside the object N with reference to the optical axis 12A, or the object N may be disposed inside the object M with reference to the optical axis 12A. That is, in a radial direction to the optical axis 12A, the object N disposed in the position which is close to the optical axis 12A may be disposed inside the object M disposed in the position which is distant from the optical axis 12A, and the object M disposed in the position which is distant from the optical axis 12A may be disposed outside the object N disposed in the position which is close to the optical axis 12A.

That is, the second supply port 22 in the present embodiment is disposed outside the liquid recovery port 20 with reference to the optical axis 12A of the terminal optical device 12. The second supply port 22 in the present embodiment is disposed in an annular shape in the XY plane to surround the liquid recovery port 20.

The second supply port 22 may have a shape which is not the annular shape, which surrounds the liquid recovery port 20. In the present embodiment, the number of the second supply ports 22 is one, but a plurality of second supply ports may be used. In a case where the plurality of second supply ports is used, the plurality of second supply ports may be disposed along an outer periphery portion of the lower surface 19B. In the case of the plurality of second supply ports is used, liquid supply amounts may be the same or may be different, in the respective second supply ports. The areas of the openings of the respective plurality of second supply ports may be the same or may be different. Further, in the present embodiment, the appearance shape of the liquid recovery port 20 and the outer periphery shape of the lower surface 19B are the same, but the appearance shape of the liquid recovery port 20 may be different from the outer periphery shape of the lower surface 19B. The liquid immersion member 7 includes the first supply port 21, the second supply port 22 and the liquid recovery port 20, but at least one of the first supply port 21, the second supply port 22 and the liquid recovery port 20 may be included in a member which is different from the liquid immersion member 7. In this case, the member which includes at least one of the first supply port 21, the second supply port 22 and the liquid recovery port 20 may be in contact with or may not be in contact with the liquid immersion member 7. For example, the first supply port 21 and the liquid recovery port 20 may be disposed in the liquid immersion member 7, and the second supply port 22 may be disposed in the member which is different from the liquid immersion member 7.

In the present embodiment, a liquid-repellent section 24 is disposed outside the second supply port 22 with reference to the optical axis 12A. In the present embodiment, the liquid-repellent section 24 is disposed outside the second supply port 22 with reference to the opening 7K. The liquid-repellent section 24 is liquid-repellent to at least the cleaning liquid LC. The liquid-repellent section 24 in the present embodiment is disposed to surround the second supply port 22 in an annular shape. The liquid-repellent section 24 in the present embodiment has an annular shape which surrounds the optical axis 12A (opening 7K). The liquid-repellent section 24 in the present embodiment is disposed between an outer periphery 16A of the main body section 16 and an outer periphery 22A of the second support port 22. In the present embodiment, the liquid-repellent section 24 is disposed in the entire region between the outer periphery 16A of the main body section 16 and the outer periphery 22A of the second support port 22. An outer periphery 24A of the liquid-repellent section 24 in the present embodiment coincides with the outer periphery portion 16A of the main body section 16. Further, an inner periphery 24B of the liquid-repellent section 24 in the present embodiment coincides with the outer periphery portion 22A of the second support port 22.

The liquid-repellent section 24 may not be provided. Further, with reference to the opening 7K or the optical axis 12A, a liquid-repellent section which is liquid-repellent to at least the cleaning liquid LC may be disposed inside the second supply port 22. In this case, the liquid-repellent section 24 may be provided or may not be provided.

The liquid-repellent section 24 and the lower surface 15B of the liquid immersion member 7 may be disposed to have substantially the same surface. Further, the liquid-repellent section 24 and the lower surface 15B of the liquid immersion member 7 may be disposed at different positions in the Z axis direction.

The second supply port 22 in the present embodiment is capable of supplying the cleaning liquid LC (LC1 and LC2) inside the liquid-repellent section 24. The liquid-repellent section 24 has the liquid-repellent property to a liquid such as a cleaning liquid supplied from the second supply port 22. In the present embodiment, a contact angle of the cleaning liquid LC with respect to the liquid-repellent section 24 is 80° or more, 90° or more, 100° or more, 110° or more, or 120° or more.

The outer periphery 24A of the liquid-repellent section 24 may not coincide with the outer periphery portion 16A of the main body section 16. For example, the outer periphery 24A of the liquid-repellent section 24 may be formed in an inside portion compared with the outer periphery 16A of the main body section 16 with reference to the optical axis 12A. In this case, the outer periphery 24A of the liquid-repellent section 24 may be an annular shape. An inner periphery 24B of the liquid-repellent section 24 in the present embodiment may not coincide with the outer periphery portion 22A of the second supply port 22.

In the present embodiment, the liquid-repellent section 24 disposed outside the second supply port 22 is a liquid-repellent film which is coated on the lower surface 14 of the liquid immersion member 7. The liquid-repellent section 24 may be formed of a member different from the main body section 16. In a case where the liquid-repellent section 24 is formed of the member different from the main body section 16, the outer periphery 24A of the liquid-repellent section 24 may not coincide with the appearance of the main body section 16. For example, the outer periphery 24A of the liquid-repellent section 24 may be larger than the main body section 16.

The liquid-repellent section 24 in the present embodiment is formed of a material including fluorine. For example, the material is fluorine-contained resin (fluorinated resin), which may be polytetrafluoroethylene (PFA) or polytetrafluoroethylene (PTEF). Further, this may be a material which is different from the material including fluorine. The material different from the material including fluorine may be, for example, a material including titanium or a material including silicon carbonitride. Further, this may be a combination of the material including fluorine and a material including other materials.

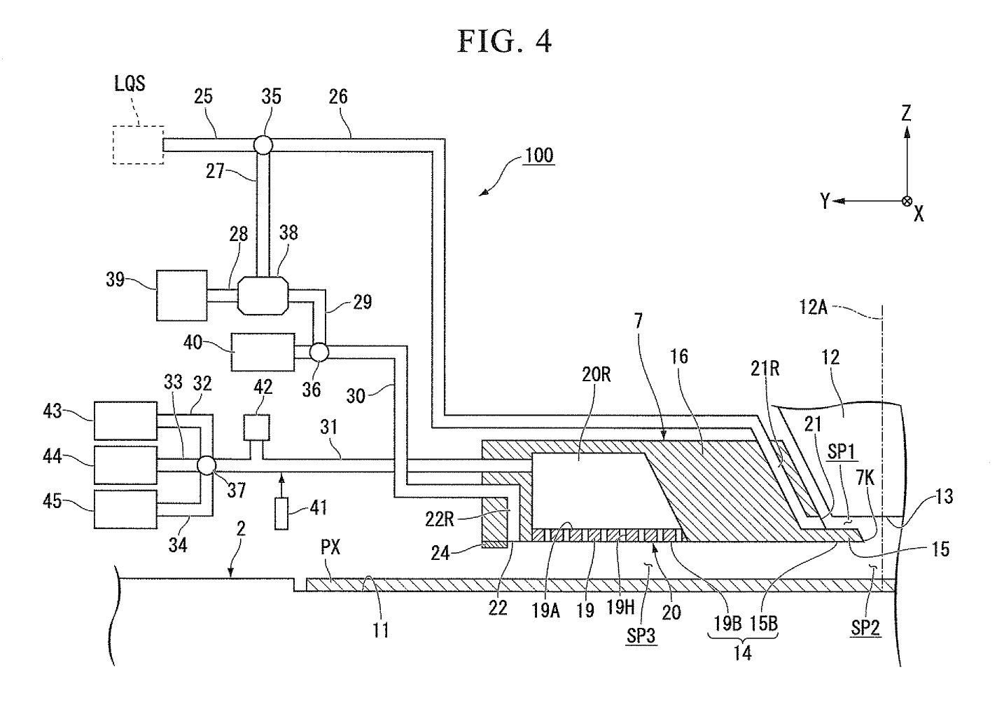

FIG. 4 is a diagram illustrating an example of a liquid system 100 according to the present embodiment. FIG. 4 shows a state where a substrate PX selected according to the operation of the exposure apparatus EX is disposed on the substrate stage 2. The substrate PX is appropriately selected from plural types of substrate including one or more types from a substrate P used for the exposure operation, a cleaning substrate CP used for a non-exposure operation such as cleaning, and a dummy substrate used for a non-exposure operation such as measurement other than cleaning.

The liquid system 100 may be a part of a device manufacturing system including the exposure apparatus EX, for example. In a case where the device manufacturing system includes the plurality of exposure apparatuses EX, the liquid system 100 may be configured to supply liquids to two or more exposure apparatuses among the plurality of exposure apparatuses EX. The liquid system 100 may be an external apparatus of the exposure apparatus EX (apparatus different from the exposure apparatus EX). Further, at least a part of the liquid system 100 may employ facilities of a factory in which the exposure apparatus EX is installed. Further, the exposure apparatus EX may include a part of the liquid system 100 or the entirety thereof.

In the present embodiment, at least one of the first supply port 21, the second supply port 22 and the liquid recovery port 20 is connected to the liquid system 100. The liquid system 100 in the present embodiment is capable of supplying the exposure liquid LQ to the first interior liquid passage 21R of the liquid immersion member 7. The exposure liquid LQ supplied to the first interior liquid passage 21R is transferred to the first supply port 21 through the first interior liquid passage 21R, and is supplied to the space SP1 through the first supply port 21.

The liquid system 100 in the present embodiment is also capable of supplying the exposure liquid LQ to the second interior liquid passage 22R of the liquid immersion member 7. The exposure liquid LQ supplied to the second interior liquid passage 22R is transferred to the second supply port 22 through the second interior liquid passage 22R. The exposure liquid LQ from the liquid system 100 is supplied to at least a part of the space SP3 of the second supply port 22 and the opening 7K which is a lower side (−Z side) space of the liquid recovery port 20, through the second supply port 22. The liquid system 100 according to the present embodiment is capable of supplying the cleaning liquid LC to the second interior liquid passage 22R of the liquid immersion member 7. The cleaning liquid LC supplied to the second interior liquid passage 22R is supplied to at least a part of the space SP3, through the second interior liquid passage 22R and the second supply port 22, in a similar way to the exposure liquid LQ.

The liquid system 100 in the present embodiment is capable of recovering the liquid (at least one of the exposure liquid LQ and the cleaning liquid LC) recovered through the liquid recovery port 20. The liquid recovered through the liquid recovery port 20 is transferred to the liquid system 100 through the third interior liquid passage 20R. For example, the exposure liquid LQ recovered through the liquid recovery port 20 in the exposure of the substrate P is transferred to the liquid system 100. The liquid system 100 may recover the liquid (at least one of the exposure liquid LQ and the cleaning liquid LC) recovered through the second supply port 22. For example, in the exposure of the substrate P, the liquid system 100 may be configured to recover the exposure liquid LQ through the second supply port 22.

Hereinafter, configuration elements of the liquid system 100 will be described. The liquid system 100 in the present embodiment includes a supply source LQS, liquid passage members 25 to 34, valves 35 to 37, a diluting device 38, a first cleaning liquid supply device 39, a second cleaning liquid supply device 40, a suction device 41, a detection device 42, and containing members 43 to 45. The supply source LQS is capable of supplying the exposure liquid LQ. The supply source LQS may be a part of the exposure apparatus EX or a part of the liquid system 100, or may be an external apparatus of the exposure apparatus EX as a part of a system which is different from the liquid system 100.

The liquid passage members 25 to 34 respectively include a pipe member such as a pipe. The valves 35 to 37 can perform at least one of flow rate adjustment and liquid passage switching. The diluting device 38 is capable of mixing two or more liquids at a desired mixing ratio. The diluting device 38 is capable of adjusting the ratio (density), in the mixed liquid, of each component included in the liquid before mixing. The first cleaning liquid supply device 39 is capable of supplying a first cleaning liquid LC1 as one of the cleaning liquid LC. The second cleaning liquid supply device 40 is capable of supplying a second cleaning liquid LC2 as one of the cleaning liquid LC. The second cleaning liquid LC2 in the present embodiment is a cleaning liquid having a component different from that of the first cleaning liquid LC1. The suction device 41 is, for example, a pump or the like, and is capable of changing pressure in a region connected to the suction device 41. The detecting device 42 is capable of detecting characteristics of the liquid. The containing members 43 to 45 are, for example, tanks, which are capable of accommodating the liquids.

In the present embodiment, a first supply system which is capable of supplying the exposure liquid LQ to the first supply port 21 includes the liquid passage member 25, the valve 35, the liquid passage member 26, and the first interior liquid passage 21R. One end of the liquid passage member 25 is connected to the supply source LQS. The other end of the liquid passage member 25 is connected to an inlet of the valve 35. The valve 35 includes two outlets, and can adjust flow rate through each outlet port. The valve 35 can selectively select an outlet through which the exposure liquid LQ flows, among two outlets, for example. The first outlet of the valve 35 is connected to one end of the liquid passage member 26. The other end of the liquid passage member 26 is connected to the first interior liquid passage 21R.

In the present embodiment, a second supply system which is capable of supplying the exposure liquid LQ to the second supply port 22 includes the liquid passage member 25, the valve 35, the liquid passage member 27, the diluting device 38, the liquid passage member 29, the valve 36, the liquid passage member 30 and the second interior liquid passage 22R. In the present embodiment, a third supply system which is capable of supplying the first cleaning liquid LC1 to the second supply port 22 includes the first cleaning liquid supply device 39, the liquid passage member 28, the diluting device 38, the liquid passage member 29, the valve 36, the liquid passage member 30, the second interior liquid passage 22R. In the present embodiment, a fourth supply system which is capable of supplying the second cleaning liquid LC2 to the second supply port 22 includes the second cleaning liquid supply device 40, the valve 36, the liquid passage member 30, and the second interior liquid passage 22R.

The second outlet among the outlets of the valve 35 is connected to one end of the liquid passage member 27. The other end of the liquid passage member 27 is connected to the diluting device 38. The diluting device 38 includes two inlets and one outlet. The first inlet of the diluting device 38 is connected to the other end of the liquid passage member 27. The second inlet of the diluting device 38 is connected to the first cleaning liquid supply device 39 through the liquid passage member 28. The outlet of the diluting device 38 is connected to one end of the liquid passage member 29.

The first cleaning liquid supply device 39 is capable of supplying the first cleaning liquid LC1 to the diluting device 38 through the liquid passage member 28. The diluting device 38 selects one of the exposure liquid LQ, the first cleaning liquid LC1 and a mixed liquid of the exposure liquid LQ and the first cleaning liquid LC1, to thereby flow the selected liquid to the liquid passage member 29.

The diluting device 38 is capable of adjusting the mixing ratio of the exposure liquid LQ and the first cleaning liquid LC1. The diluting device 38 is capable of adjusting the flow rate of the liquid flowing to the liquid passage member 29. In the following description, the mixture of the exposure liquid LQ and the first cleaning liquid LC1 may be simply referred to as the first cleaning liquid LC1.

The other end of the liquid passage member 29 is connected to the valve 36. The valve 36 includes two inlets and one outlet. The first inlet of the valve 36 is connected to the other end of the liquid passage member 29. The second inlet of the valve 36 is connected to the second cleaning liquid supply device 40. The outlet of the valve 36 is connected to one end of the liquid passage member 30.

The second cleaning liquid supply device 40 is capable of supplying the second cleaning liquid LC2 to the second inlet of the valve 36. The valve 36 selects one of the exposure liquid LQ or the first cleaning liquid LC1 inflowing from the liquid passage member 29, the second cleaning liquid LC2, a mixed liquid of the exposure liquid LQ and the second cleaning liquid LC2, and a mixed liquid of the first cleaning liquid LC1 and the second cleaning liquid LC2 inflowing from the liquid passage member 29, to thereby flow the selected liquid to the liquid passage member 30. In the following description, the mixture of the exposure liquid LQ and the second cleaning liquid LC2 may be simply referred to as the second cleaning liquid LC2.

The other end of the liquid passage member 30 is connected to the second interior liquid passage 22R. In this way, the exposure liquid LQ, the first cleaning liquid LC1, the second cleaning liquid LC2, the mixed liquid of the first cleaning liquid LC1 and the second cleaning liquid LC2 can be selected and supplied to the space SP3 through the second supply port 22.

In the present embodiment, a liquid recovery system which is capable of recovering the liquid through the liquid recovery port 20 includes the third interior liquid passage 20R, the liquid passage member 31, the suction device 41, the detection device 42, the valve 37, the liquid passage members 32 to 34, and the containing members 43 to 45. One end of the liquid passage member 31 is connected to the third interior liquid passage 20R. The other end of the liquid passage member 31 is connected to the valve 37. In the present embodiment, the suction device 41 and the detection device 42 are connected to the liquid passage in the liquid passage member 31.

The suction device 41 suctions the liquid of the third interior liquid passage 20R to the side of the liquid passage member 31. The suction device 41 in the present embodiment makes pressure of the liquid passage in the liquid passage member 31 and the third interior liquid passage 20R different from pressure in the space SP3, to thereby suction the liquid which exists in the space SP3 through the liquid recovery port 20 (holes 19H of the porous member 19). The liquid recovery port 20 may be configured to selectively recover the liquid among the liquid and gas which exist in the space SP3, or may be configured to recover the liquid and gas.

The detection device 42 measures characteristics of the liquid flowing to the liquid passage member 31 through the third interior liquid passage 20R. The liquid characteristics include at least one of physical characteristics and components. The physical characteristics include at least one of density and conductivity. The detection result of the detection device 42 may be output to the control device 8, for example. The control device 8 may obtain the liquid characteristics on the basis of the detection result of the detection device 42.

The valve 37 includes one inlet and three outlets. The inlet of the valve 37 is connected to the other end of the liquid passage member 31. The first outlet of the valve 37 is connected to the containing member 43 through the liquid passage member 32. The second outlet of the valve 37 is connected to the containing member 44 through the liquid passage member 33. The third outlet of the valve 37 is connected to the containing member 45 through the liquid passage member 34. The valve 37 is capable of adjusting the flow rate of the liquid which outflows through the first to third outlets. The valve 37 in the present embodiment is capable of selecting which one of the first to third outlets the liquid flows through, according to the characteristics of the liquid which inflows to the valve 37 through the liquid passage member 31, on the basis of the detection result of the detection device 42, for example. The containing members 44 to 46 according to the present embodiment are tanks. The liquid system 100 in the present embodiment can separately recover the liquid into the containing members 43 to 45, according to the characteristics of the liquid in the third interior liquid passage 20R.

The first supply system which is capable of supplying the exposure liquid LQ to the first supply port 21 and the second supply system which is capable of supplying the exposure liquid LQ to the second supply port 22 may not have a common liquid passage. The third supply system 3 which is capable of supplying the first cleaning liquid LC1 to the second supply port 22 and the fourth supply system 4 which is capable of supplying the second cleaning liquid LC2 to the second supply port 22 may not have a common liquid passage. All the first to fourth supply systems may not have a common liquid passage. Two or more supply systems among the first to fourth supply systems may have the common liquid passage.

Next, an example of a method of exposing the substrate P using the exposure apparatus EX according to the present embodiment will be described with reference to FIGS. 1 to 4.

The control device 8 moves the substrate stage 2 to a substrate exchange position in order to load the substrate P before exposure to the substrate stage 2. The substrate exchange position is a position separated from the liquid immersion member 7 (projection region PR), in which an exchange process of the substrate P can be performed. The exchange process of the substrate P includes at least one of a process of unloading the substrate P after exposure from the substrate stage 2, which is held by the substrate stage 2 (substrate holding section 11), using a predetermined transport position (not shown), and a process of loading the substrate P before exposure to the substrate stage 2 (substrate holding section 11). The control device 8 moves the substrate stage 2 to the substrate exchange position to perform the exchange process of the substrate P.

During at least a part of a period when the substrate stage 2 is separated from the liquid immersion member 7, the control device 8 disposes the measurement stage 3 in a position where it faces the terminal optical device 12 and the liquid immersion member 7, and holds the exposure liquid LQ between the terminal optical device 12 and the liquid immersion member 7 and the measurement stage 3 to form the liquid immersion space LS.

Further, during at least a part of the period when the substrate 2 is separated from the liquid immersion member 7, a measurement process which uses the measurement stage 3 may be performed as necessary. When the measurement process which uses the measurement stage 3 is performed, the control device 8 makes the terminal optical device 12 and the liquid immersion member 7 face the measurement stage 3, and forms the liquid immersion space LS so that the optical path K of the exposure light EL between the terminal optical device 12 and the measurement member C is filled with the exposure liquid LQ. The control device 8 irradiates the measurement member C (measuring instrument) held by the measurement stage 3 with the exposure light EL through the projection optical system PL and the exposure liquid LQ, to perform the measurement process of the exposure light EL. A result of the measurement process may be reflected to the exposure process of the substrate P which is performed thereafter.

After the substrate P before exposure is loaded to the substrate stage 2 and the measurement process which uses the measurement stage 3 is completed, the control device 8 moves the substrate stage 2 to the projection region PR, to form the liquid immersion space LS between the terminal optical device 12 and the liquid immersion member 7, and the substrate stage 2 (substrate P).

The exposure liquid LQ supplied from the supply source LQS is supplied to the first supply port 21 through the liquid passage in the liquid passage member 26 and the first interior liquid passage 21R. The first supply port 21 supplies the exposure liquid LQ to the space SP1 (optical path K). The exposure liquid LQ supplied to the space SP1 flows to the space SP2 through the opening 7K. Further, the recovery operation of the exposure liquid LQ through the liquid recovery port 20 is performed together with the supply operation of the exposure liquid LQ through the first supply port 21. Thus, the liquid immersion space LS is formed by the exposure liquid LQ between the terminal optical device 12 and the liquid immersion member 7, and the substrate P (substrate stage 2).

The liquid recovery port 20 recovers the exposure liquid LQ in the space SP2. The exposure liquid LQ recovered through the liquid recovery port 20 flows along the third interior liquid passage 20R and the liquid passage in the liquid passage member 31. In the present embodiment, the liquid passage is adjusted by the valve 37 so that the exposure liquid LQ recovered through the liquid recovery port 20 flows along the liquid passage in the liquid passage member 32. The exposure liquid LQ discharged from the liquid passage member 32 flows into the containing member 43.

After the liquid immersion space LS is formed between the terminal optical device 12 and the liquid immersion member 7, and the substrate stage 2 (substrate P), the control device 8 starts the exposure process of the substrate P. When the exposure process of the substrate P is performed, the terminal optical device 12 and the liquid immersion member 7, and the substrate P are disposed to face each other, and the liquid immersion space LS is formed so that the optical path K of the exposure light EL between the terminal optical device 12 and the substrate P is filled with the exposure liquid LQ.

The illumination system IL illuminates the mask M with the exposure light EL. The exposure light EL passing through the mask M irradiates the substrate P through the projection optical system PL and the exposed liquid LQ supplied through the first supply port 21. Thus, the substrate P is exposed with the exposure light EL emitted from the terminal optical device 12. The image of the pattern of the mask M is projected to the substrate P.

The exposure apparatus EX according to the present embodiment is a scanning exposure apparatus (commonly called a scanning stepper) which projects the pattern image of the mask M onto the substrate P while synchronously moving the mask M and the substrate P in a predetermined scanning direction. In the present embodiment, the scanning direction (sync movement direction) of the substrate P is the Y axis direction, and the scanning direction (sync movement direction) of the mask M is the Y axis direction. The control device 8 irradiates the substrate P with the exposure light EL through the projection optical system PL and the exposure liquid LQ in the liquid immersion space LS on the substrate P, while moving the substrate P in the Y axis direction with respect to the projection region PR of the projection optical system PL and moving the mask M in the Y axis direction with respect to the illumination region IR of the illumination system IL in synchronization with the movement of the substrate P in the Y axis direction.

After the exposure process of the substrate P is completed, the control device 8 moves the substrate stage 2 to the substrate exchange position. The measurement stage 3 is disposed to face, for example, the terminal optical device 12 and the liquid immersion member 7. The substrate P after exposure is unloaded from the substrate stage 2 moved to the substrate exchange position, and the substrate P before exposure is loaded to the substrate stage 2. Hereinafter, the control device 8 repeats the above-described processes to sequentially expose the plurality of substrates P.

In the present embodiment, during at least a part of the exposure sequence including the exchange process of the substrate P, the measurement process which uses the measurement stage 3 and the exposure process of the substrate P, the exposure liquid LQ is supplied through the first supply port 21 between the terminal optical device 12 and the liquid immersion member 7, and the object (at least one of the substrate P, the substrate stage 2 and the measurement stage 3) disposed to face the terminal optical device 12 and the liquid immersion member 7 and at least a part of the exposure liquid LQ supplied through the first supply port 21 is recovered through the liquid recovery port 20. In the exposure sequence, the exposure liquid LQ recovered through the liquid recovery port 20 is transferred to the containing member 43.

In the present embodiment, in the period of the exposure sequence, the cleaning liquid is not supplied from any one of the first cleaning liquid supply device 39 and the second cleaning liquid supply device 40. That is, during the period of the exposure sequence, the liquid supply through the second supply port 22 is stopped.

During the period of the exposure sequence, the second supply port 22 is connected to a vacuum system (vacuum pump or the like) and the exposure liquid LQ may be recovered through the second supply port 22.

However, during the exposure of the substrate P, there is a possibility that substances (for example, organic substances such as photosensitive material) generated (eluted) from the substrate P is mixed into the exposure liquid LQ in the liquid immersion space LS as foreign substances (contaminants, particles). Further, in addition to the substances generated from the substrate P, for example, there is also a possibility that foreign substances floating in the air are mixed into the exposure liquid LQ in the liquid immersion space LS. As described above, during the period of at least a part of the exposure sequence including the exchange process of the substrate P, the measurement process which uses the measurement stage 3, and the exposure process of the substrate P, the exposure liquid LQ in the liquid immersion space LS is in contact with at least a part of the terminal optical device 12, the liquid immersion member 7, the substrate stage 2 and the measurement stage 3.

Accordingly, if foreign substances are mixed into the exposure liquid LQ in the liquid immersion space LS, there is a possibility that the foreign substances are attached to at least a part of the emitting surface 13 of the terminal optical device 12, the lower surface 14 of the liquid immersion member 7, the porous member 19 disposed in the liquid recovery port 20, the upper surface 2F of the substrate stage 2 and the upper surface 3F of the measurement stage 3. If a state is maintained where the foreign substances are attached to the surface (liquid contact surface) of a liquid-contacted member in the exposure apparatus EX which is in contact with the exposure liquid LQ, there is a possibility that the foreign substances are attached to the substrate P during exposure or the exposure liquid LQ supplied through the first supply port 21 is contaminated. Further, if at least one of the emitting surface 13 of the terminal optical device 12, the lower surface 14 of the liquid immersion member 7, the upper surface 2F of the substrate stage 2 and the upper surface 3F of the measurement stage 3 is contaminated, for example, there is a probability that the liquid immersion space LS is not preferably formed. As a result, there is a probability that poor exposure occurs.

In the present embodiment, the cleaning process is performed at a predetermined timing for the member in the exposure apparatus EX which is in contact with the exposure liquid LQ in the liquid immersion space LS. In the present embodiment, the cleaning process is performed using the cleaning liquid LC. Hereinafter, an example of a cleaning sequence including the cleaning process of the liquid immersion member 7 among the members of the exposure apparatus EX will be described.

In the cleaning sequence, the object is disposed in a position which faces the lower surface 14 of the liquid immersion member 7. The object may be, for example, the substrate stage 2 (upper surface 2F), the measurement stage 3 (upper surface 3F) or the substrate PX held by the substrate holding section 11 of the substrate stage 2. As described above, the substrate PX may include at least one of the substrate P used for the exposure operation, the cleaning substrate CP used for the non-exposure operation such as cleaning, and the dummy substrate used for the non-exposure operation other than cleaning, such as measurement.

In a state where the lower surface 14 of the liquid immersion member 7 faces the object, the control device 8 supplies the cleaning liquid LC through the second supply port 22. Further, the control device 8 performs the supply of the cleaning liquid LC through the second supply port 22 and the operation of recovering at least a part of the cleaning liquid LC supplied through the second supply port 22 through the liquid recovery port 20.

The cleaning liquid LC supplied through the second supply port 22 is supplied between the liquid immersion member 7 and the object. Further, at least a part of the cleaning liquid LC supplied through the second supply port 22 is held between the liquid immersion member 7 and the object. The cleaning liquid LC supplied through the second supply port 22 is in contact with at least a part of the lower surface 14 of the liquid immersion member 7 including the lower surface 198 of the porous member 19. Thus, at least a part of the lower surface 14 is cleaned by the cleaning liquid LC. Further, the cleaning liquid LC supplied through the second supply port 22 is in contact with at least a part of the surface of the object disposed in the position which faces the liquid immersion member 7. Thus, at least a part of the surface of the object is also cleaned by the cleaning liquid LC.

The cleaning liquid LC between the liquid immersion member 7 and the object is recovered through the liquid recovery port 20 (holes 19H). The cleaning liquid LC is in contact with at least a part of the inner surfaces of the holes 19H and the upper surface 19A of the porous member 19. Thus, at least a part of the inner surfaces of the holes 19H and the upper surface 19A is cleaned by the cleaning liquid LC. Further, the cleaning liquid LC is in contact with at least a part of the inner surface of the third interior liquid passage 20R. Thus, at least a part of the inner surface of the third interior liquid passage 20R is cleaned by the cleaning liquid LC.

In the present embodiment, since the second supply port 22 of the liquid immersion member 7 is disposed outside the liquid recovery port 20 with reference to the opening 7K (optical axis 12A), the cleaning liquid LC is suppressed from flowing into the space between the lower surface 15B and the object. Accordingly, the cleaning liquid LC is suppressed from passing through the opening 7K. That is, the cleaning liquid LC is suppressed from flowing into the space on the side of the upper surface 15A from the space on the side of the lower surface 15B through the opening 7K.

As described above, the cleaning liquid LC in the present embodiment includes the first cleaning liquid LC1 and the second cleaning liquid LC2. In the present embodiment, in the cleaning sequence, firstly, the first cleaning liquid LC1 is supplied through the second supply port 22. The first cleaning liquid LC1 which is supplied through the second supply port 22 and which is recovered through the liquid recovery port 20 flows along the third interior liquid passage 20R and the liquid passage in the liquid passage member 31. In the present embodiment, the liquid passage is adjusted by the valve 37 so that the first cleaning liquid LC1 recovered through the liquid recovery port 20 is discharged to the containing member 44. That is, the first cleaning liquid LC1 recovered through the liquid recovery port 20 is supplied to the containing member 44.

After the first cleaning liquid LC1 is supplied through the second supply port 22 for a predetermined time, the control device 8 stops the supply of the first cleaning liquid LC1 through the second supply port 22.

After the cleaning process which uses the first cleaning liquid LC1 is completed, the exposure liquid LQ is supplied through the second supply port 22. The exposure liquid LQ has a function of removing the first cleaning liquid LC1 which remains in the liquid immersion member 7 or the like. In the following description, a liquid for removing the cleaning liquid LC (LC1 and LC2) which remains the liquid immersion member 7 or the like is appropriately referred to as a rinse liquid. In the present embodiment, the exposure liquid LQ (water) is used as the rinse liquid.

The rinse liquid LQ supplied through the second supply port 22 is recovered through the liquid recovery port 20. The rinse liquid LQ which is supplied through the second supply port 22 and is recovered through the liquid recovery port 20 flows along the third interior liquid passage 20R and the liquid passage in the liquid passage member 31. In the present embodiment, the liquid passage is adjusted by the valve 37 so that the rinse liquid LQ which is recovered through the liquid recovery port 20 is discharged to the containing member 44. That is, the rinse liquid LQ which is recovered through the liquid recovery port 20 is supplied to the containing member 44.

The rinse liquid LQ is supplied through the second supply port 22 for a predetermined time, the control device 8 stops the supply of the rinse liquid LQ through the second supply port 22.

After the rinse process of removing the cleaning liquid LC (the first cleaning liquid LC1) which remains the liquid immersion member 7 or the like using the rinse liquid LQ is completed, the second cleaning liquid LC2 is supplied through the second supply port 22.

The second cleaning liquid LC2 supplied through the second supply port 22 is recovered through the liquid recovery port 20. The second cleaning liquid LC2 which is supplied through the second supply port 22 and is recovered through the liquid recovery port 20 flows along the third interior liquid passage 20R and the liquid passage in the liquid passage member 31. In the present embodiment, the liquid passage is adjusted by the valve 37 so that the second cleaning liquid LC2 which is recovered through the liquid recovery port 20 is discharged to the containing member 45. That is, the rinse liquid LQ which is recovered through the liquid recovery port 20 is supplied to the containing member 45.

After the cleaning process which uses the second cleaning liquid LC2 is completed, the rinse liquid LQ is supplied through the second supply port 22. Thus, the second cleaning liquid LC2 which remains in the liquid immersion member 7 or the like is removed by the rinse liquid LQ.

The rinse liquid LQ which is supplied through the second supply port 22 is recovered through the liquid recovery port 20. The rinse liquid LQ which is supplied through the second supply port 22 and is recovered through the liquid recovery port 20 flows along the third interior liquid passage 20R and the liquid passage in the liquid passage member 31. In the present embodiment, the liquid passage is adjusted by the valve 37 so that the rinse liquid LQ which is recovered through the liquid recovery port 20 is discharged to the containing member 45. That is, the rinse liquid LQ which is recovered through the liquid recovery port 20 is supplied to the containing member 45.

After the rinse liquid LQ is supplied through the second supply port 22 for a predetermined time, the control device 8 stops the supply of the rinse liquid LQ through the second supply port 22.

Through the above processes, the cleaning sequence is completed. According to the present embodiment, it is possible to clean at least one of the liquid immersion member 7 and the object (the substrate stage 2, the measurement stage 3 or the like) using the cleaning liquid LC. Accordingly, it is possible to suppress the occurrence of poor exposure and a defective device.

In the cleaning sequence of the present embodiment, the supply of the liquid (the cleaning liquid LC, the rinse liquid LQ or the like) through the second supply port 22 and the recovery of the liquid through the liquid recovery port 20 (the holes 19H) are performed in parallel. However, the liquid of a predetermined amount may be supplied through the second supply port 22 between the liquid immersion member 7 and the object to hold the liquid between the liquid immersion member 7 and the object, the supply of the liquid may be then stopped through the second supply port 22, and thereafter, the operation of recovering at least a part of the liquid which is held between the liquid immersion 7 and the object through the liquid recovery port 20 may be started. That is, a start timing of the liquid supply through the second supply port 22, a stop timing of the liquid supply through the second supply port 22, a start timing of the liquid recovery through the liquid recovery port 20, or the like may be appropriately determined.

In the present embodiment, the first cleaning liquid LC1 and the second cleaning liquid LC2 are used as the cleaning liquid LC, but the cleaning of the liquid immersion member 7 or the like may be performed using only one of the first cleaning liquid LC1 and the second cleaning liquid LC2. Further, the cleaning of the liquid immersion member 7 or the like may be performed using a third cleaning liquid which is different from the first cleaning liquid LC1 and the second cleaning liquid LC2, as the cleaning liquid LC, in addition to the first cleaning liquid LC1 and the second cleaning liquid LC2. That is, in the cleaning of the liquid immersion member 7 or the like, one type of cleaning liquid may be used, two types of cleaning liquid may be used, three types of cleaning liquid may be used, or four or more types of cleaning liquid may be used. Further, in the cleaning sequence in the present embodiment, the rinse process of removing the cleaning liquid LC (the first and second cleaning liquids LC1 and LC2) which remains in the liquid immersion member 7 or the like using the rinse liquid LQ is performed, but the rinse liquid LQ may not be supplied. That is, the rinse process may be omitted. Further, the liquid immersion member 7 or the like may be cleaned only using the exposure liquid LQ, without using the cleaning liquid LC. That is, the exposure liquid LQ may be supplied through the second supply port 22, and may be recovered through the liquid recovery port 22, without using the cleaning liquid LC.

In the cleaning sequence according to the present embodiment, the liquid (the cleaning liquid LC, the rinse liquid LQ or the like) is supplied through the second supply port 22 and at least a part of the liquid which is supplied through the second supply port 22 is recovered through the liquid recovery port 20 (the holes 19H). However, instead of this sequence, before or after this sequence, or before and after this sequence, for example, the liquid (the cleaning liquid LC, the rinse liquid LQ or the like) may be supplied through the liquid recovery port 20 (the holes 19H) between the liquid immersion member 7 and the object (the substrate stage 2, the measurement stage 3, the substrate PX, or the like) which faces the liquid immersion member 7, and at least a part of the liquid between the liquid immersion member 7 and the object may be recovered through the second supply port 22 which is disposed outside the liquid recovery port 20. That is, in the cleaning sequence, the liquid recovery port 20 may function as the liquid supply port, and the second supply port 22 may function as the liquid recovery port. In this case, the supply of the liquid through the liquid recovery port 20 and the recovery of the liquid through the second supply port 22 may be performed in parallel. Alternatively, the liquid of a predetermined amount may be supplied through the liquid recovery port 20 between the liquid immersion member 7 and the object to hold the liquid between the liquid immersion member 7 and the object, the supply of the liquid may be then stopped through the liquid recovery port 20, and thereafter, the operation of recovering at least a part of the liquid which is held between the liquid immersion member 7 and the object through the second supply port 22 may be started. That is, a start timing of the liquid supply through the liquid recovery port 20, a stop timing of the liquid supply through the liquid recovery port 20, a start timing of the liquid recovery through the second supply port 22, or the like may be appropriately determined.

Further, in the cleaning sequence, the cleaning liquid LC which is supplied through the second supply port 22 may be recovered through the liquid recovery port 20 and the rinse liquid LQ which is supplied through the liquid recovery port 20 may be recovered through the second liquid supply port 22, or the cleaning liquid LC which is supplied through the liquid recovery port 20 may be recovered through the second liquid supply port 22 and the rinse liquid LQ which is supplied through the second supply port 22 may be recovered through the liquid recovery port 20.

Instead of the cleaning sequence in the present embodiment, before or after this sequence, or before and after this sequence, the liquid (the cleaning liquid LC, the rinse liquid LQ or the like) of a predetermined amount may be supplied through the liquid recovery port 20 between the liquid immersion member 7 and the object to hold the liquid between the liquid immersion member 7 and the object, the supply of the liquid may be then stopped through the liquid recovery port 20, and thereafter, the operation of recovering at least a part of the liquid which is held between the liquid immersion 7 and the object through the liquid recovery port 20 may be started. That is, in the cleaning sequence, the liquid recovery port 20 (holes 19H) may function as the liquid supply port and the liquid recovery port. In this case, the liquid through the second supply port 22 may not be provided.

In the present embodiment, an alkaline liquid may be used as the first cleaning liquid LC1. That is, an alkaline solution including a predetermined substance may be used as the first cleaning liquid LC1. For example, the first cleaning liquid LC1 may include tetramethyl ammonium hydroxide (TMAH) as the predetermined substance. Further, an alkaline aqueous solution may be used as the first cleaning liquid LC1.

Further, in the present embodiment, an acid liquid may be used as the second cleaning liquid LC2. That is, an acid solution including a predetermined substance may be used as the second cleaning liquid LC2. For example, the second liquid LC2 may include hydrogen peroxide as the predetermined substance. Further, an acid aqueous solution may be used as the second cleaning liquid LC2.

Further, in the present embodiment, an aqueous solution may be used as the rinse liquid. That is, an aqueous solution which includes a predetermined substance may be used as the rinse liquid. Alcohol may be included as the predetermined substance. Further, alcohol may be used as the rinse liquid. Further, the first cleaning liquid LC1 and the rinse liquid may include the same type of liquid. Further, the second cleaning liquid LC2 and the rinse liquid may include the same type of liquid.

In the present embodiment, an alkaline aqueous solution is used as the first cleaning liquid LC1. A hydrogen peroxide aqueous solution is used as the second cleaning liquid LC2. The exposure liquid LQ is used as the rinse liquid. That is, the rinse liquid LH in the present embodiment is water (pure water). Each of the first cleaning liquid LC1, the second cleaning liquid LC2 and the rinse liquid LH in the present embodiment includes water as the same type of liquid.

In the present embodiment, a tetramethyl ammonium hydroxide aqueous solution is used as the first cleaning liquid LC1. An inorganic alkaline solution such as ammonia water, sodium hydroxide solution or potassium hydroxide solution, or an organic alkaline solution such as trimethyl (2-hydroxylethyl) ammonium hydroxide, may be used as the first cleaning liquid LC1.

In the present embodiment, the hydrogen peroxide aqueous solution (hydrogen peroxide water) is used as the second cleaning liquid LC2. The second cleaning liquid LC2 may include a buffered hydrofluoric acid solution. Further, the second cleaning liquid LC2 may be a solution including buffered hydrofluoric acid and hydrogen peroxide. The buffered hydrofluoric acid is a mixture of hydrofluoric acid and ammonium fluoride. The mixing ratio may be 5 to 2,000 in a volume ratio of an ammonium fluoride solution of 40 weight % to hydrofluoric acid of 50 weight %. Further, the mixing ratio of buffered hydrofluoric acid and hydrogen peroxide may be 0.8 to 55 in a weight ratio of hydrogen peroxide to hydrofluoric acid. An ozone liquid including ozone or a mixed solution of hydrogen peroxide and a solution including ozone may be used as the second cleaning liquid LC2.

At least one of the first cleaning liquid LC1 and the second cleaning liquid LC2 may include alcohol. For example, at least one of the first cleaning liquid LC1 and the second cleaning liquid LC2 may include at least one of ethanol, isopropyl alcohol (IPA), and pentanol.

### Second Embodiment

Next, a second embodiment will be described. In the following description, component parts that are identical or equivalent to those in the above-described embodiment are assigned identical symbols, and descriptions thereof are abbreviated or omitted. Further, the variety of modifications disclosed in the first embodiment may be also applied to this embodiment.

In the present embodiment, a cleaning sequence is performed using the cleaning substrate CP. The cleaning substrate CP is a substrate used for cleaning of a liquid immersion member. The liquid immersion member may be the liquid immersion member 7 described in the first embodiment, or may be a different liquid immersion member. Hereinafter, a case where the liquid immersion member 7 among members in the exposure apparatus EX which is in contact with the exposure liquid LQ is mainly cleaned will be described as an example. The cleaning substrate CP in the present embodiment is an example of a dummy substrate according to the present embodiment. A cleaning process of a member, among the members of the exposure apparatus EX, which is not in contact with the exposure liquid LQ may be performed.

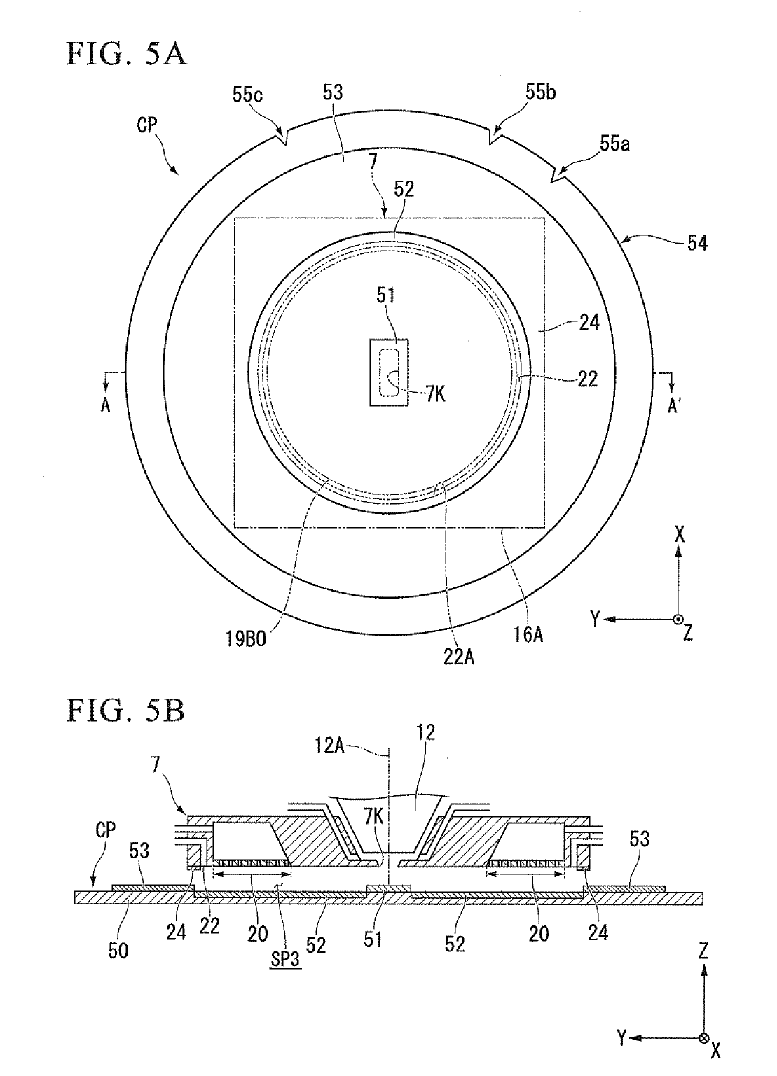

FIG. 5A is a planar view illustrating an example of the cleaning substrate according to the present embodiment, and FIG. 5B is a cross-sectional view illustrating an example of the cleaning substrate. FIG. 5B corresponds to a cross-sectional view taken line A-A′ in FIG. 5A. In the present embodiment, in at least a part of the cleaning sequence of the liquid immersion member 7, the cleaning substrate CP is disposed in a position which faces the liquid immersion member 7. In the following description, a planar view in the Z axis direction may be simply referred to as a planar view. Further, a state where relative positions between the liquid immersion member 7 and the cleaning substrate CP are adjusted to accommodate an opening 7K of the liquid immersion member 7 inside the outer periphery of a first liquid-repellent portion 51 of the cleaning substrate CP when seen from a planar view may be referred to as a positioning state. In FIGS. 5A and 5B, the cleaning substrate CP in the positioning state is shown. In the present embodiment, the outer periphery of the first liquid-repellent portion 51 of the cleaning substrate CP in the positioning state, when seen from a planar view, faces the lower surface 15B of the plate section 15.

The cleaning substrate CP in the present embodiment includes a substrate main body 50, the first liquid-repellent portion 51, a lyophilic portion 52, a second liquid-repellent portion 53, and notches 55a to 55c which are disposed in an outer periphery portion 54. The lyophilic portion and the liquid-repellent portion of the cleaning substrate CP in the present embodiment have distribution in which a cleaning operation (non-exposure operation) of the exposure apparatus EX can be performed, and/or have lyophilic properties to a predetermined liquid as defined by a contact angle or the like. At least one of the distribution of the lyophilic portion and the liquid-repellent portion of the cleaning substrate CP in the present embodiment, the contact angle of the lyophilic portion with respect to the predetermined liquid, and the contact angle of the liquid-repellent portion with respect to the predetermined liquid may be determined in association with the cleaning operation (non-exposure operation) of the exposure apparatus EX. In the present embodiment, the predetermined liquid is a liquid (including the cleaning liquid LC) used for the cleaning operation which is one of the non-exposure operations.

The appearance and size of the cleaning substrate CP in the present embodiment are approximately the same as the appearance and size of the substrate P. The substrate main body 50 is a base of the cleaning substrate CP. The substrate main body 50 includes a plate member such as a metal substrate, a silicon substrate, a glass substrate or a quartz substrate, or a composite member obtained by bonding two or more plate members. At least one of the appearance and size of the cleaning substrate CP may be different from those of the substrate P. For example, the cleaning substrate CP may have an area larger or smaller than the substrate P.

The surface of the first liquid-repellent portion 51 is liquid-repellent to the first cleaning liquid LC1. The contact angle of the first cleaning liquid LC1 with respect to the first liquid-repellent portion 51 may be 80° or more, 90° or more, 100° or more, 110° or more, or 120° or more. In the present embodiment, the contact angle of the first cleaning liquid LC1 with respect to the first liquid-repellent portion 51 is set in a range of 95° or more. The surface of the first liquid-repellent portion 51 may be even, may be uneven, may be tilted, or may be curved.

The surface of the of the first liquid-repellent portion 51 according to the present embodiment is liquid-repellent to the second cleaning liquid LC2. The contact angle of the second cleaning liquid LC2 with respect to the first liquid-repellent portion 51 may be 80° or more, 90° or more, 100° or more, 110° or more, or 120° or more. In the present embodiment, the contact angle of the second cleaning liquid LC2 with respect to the first liquid-repellent portion 51 is set in a range of 95° or more.

The surface of the first liquid-repellent portion 51 according to the present embodiment is liquid-repellent to the rinse liquid LH. The contact angle of the rinse liquid LH with respect to the first liquid-repellent portion 51 may be 80° or more, 90° or more, 100° or more, 110° or more, or 120° or more. In the present embodiment, the contact angle of the rinse liquid LH with respect to the first liquid-repellent portion 51 is set in a range of 95° or more.

The contact angles of the first cleaning liquid LC1, the second cleaning liquid LC2 and the rinse liquid LH2 with respect to the first liquid-repellent portion 51 may be different from each other. For example, in a case where the contact angle of the first cleaning liquid LC1 with respect to the first liquid-repellent portion 51 is set to 100° or more, the contact angle of the second cleaning liquid LC2 with respect to the first liquid-repellent portion 51 may be set to 80° or more. Further, the first liquid-repellent portion 51 may be liquid-repellent to only at least one of the first cleaning liquid LC1, the second cleaning liquid LC2 and the rinse liquid LH.

The first liquid-repellent portion 51 may include a liquid-repellent member (including a liquid-repellent film) disposed on the substrate main body 50. The liquid-repellent member is formed of a liquid-repellent material which is liquid-repellent to the first cleaning liquid LC1 and the second cleaning liquid LC2. The liquid-repellent material may be any one of a material including titanium, a material including fluorine, and a material including silicon carbonitride, or may be a combination of two or more of these materials, for example. The material including fluorine is, for example, fluorine-contained resin (fluorine-based resin), which may be polytetrafluoroethylene (PFA) or polytetrafluoroethylene (PTEF). The liquid-repellent member may include a member which is formed of a material including titanium and a film which is formed of a material including fluorine and is formed on this member.

In a case where the substrate main body 50 is liquid-repellent to the first cleaning liquid LC1 and the second cleaning liquid LC2, the first liquid-repellent portion 51 may include a part of the substrate main body 50. A liquid-repellent process of assigning a liquid-repellent property to the substrate main body 50 may be surface processing using a coupling material which applies an alkyl group to a surface to be processed, for example. For example, when the substrate main body 50 is a silicon substrate, by allowing a silane coupling material to act on the surface of the silicon substrate, it is possible to assign the liquid-repellent property to the surface of the silicon substrate. The first liquid-repellent portion 51 may include a portion where the liquid-repellent process is performed on the surface of the liquid-repellent member.

The lyophilic portion 52 has a liquid-repellent property of a surface thereof with respect to the first cleaning liquid LC1, which is lower than the liquid-repellent property of the surface of the first liquid-repellent portion 51 with respect to the first cleaning liquid LC1. The lyophilic portion 52 of the present embodiment has a lyophilic property to the first cleaning liquid LC1. The lyophilic portion 52 in the present embodiment has a lyophilic property to the second cleaning liquid LC2 which is equivalent to the lyophilic property to the first cleaning liquid LC1. The respective contact angles of the first cleaning liquid LC1 and the second cleaning liquid LC2 with respect to the lyophilic portion 52 are smaller than the respective contact angles of the first cleaning liquid LC1 and the second cleaning liquid LC2 with respect to the first liquid-repellent portion 51. The lyophilic portion 52 may include a lyophilic member (including a lyophilic film) disposed on the substrate main body 50. The lyophilic member may be formed of a material which has a lyophilic property to the cleaning liquid LC. The contact angle of the first cleaning liquid LC1 with respect to the lyophilic portion 52 may be larger or smaller than the contact angle of the second cleaning liquid LC2 with respect to the lyophilic portion 52.

Further, in the present embodiment, the contact angle of the first cleaning liquid LC1 with respect to the lyophilic portion 52 may be 40° or less, 30° or less, 20° or less, or 10° or less. In the present embodiment, the contact angle of the first cleaning liquid LC1 with respect to the lyophilic portion 52 is set in a range of 30° or less. Further, in the present embodiment, the contact angle of the second cleaning liquid LC2 with respect to the lyophilic portion 52 may be 40° or less, 30° or less, 20° or less, or 10° or less. In the present embodiment, the contact angle of the first cleaning liquid LC1 for the lyophilic portion 52 is set in a range of 30° or less.

Further, in the present embodiment, the contact angle of the rinse liquid LH with respect to the lyophilic portion 52 may be 40° or less, 30° or less, 20° or less, or 10° or less. In the present embodiment, the contact angle of the rinse liquid L11 with respect to the lyophilic portion 52 is set in a range of 30° or less.

The contact angles of the first cleaning liquid LC1, the second cleaning liquid LC2 and the rinse liquid LH with respect to the lyophilic portion 52 may be different from each other. The contact angle of the first cleaning liquid LC1 with respect to the lyophilic portion 52 may be larger or smaller than the contact angle of the second cleaning liquid LC2 with respect to the lyophilic portion 52. For example, in a case where the contact angle of the first cleaning liquid LC1 with respect to the lyophilic portion 52 is set to 30° or less, the contact angle of the second cleaning liquid LC2 with respect to the lyophilic portion 52 may be set to 40° or less. Further, the lyophilic portion 52 may be lyophilic to only at least one of the first cleaning liquid LC1, the second cleaning liquid LC2 and the rinse liquid LH.

In a case where the substrate main body 50 is lyophilic to the first cleaning liquid LC1 and the second cleaning liquid LC2, a part of the substrate main body 50 may be formed as the lyophilic portion 52. The lyophilic portion 52 may include a part of the substrate main body 50, and may not include a separate member which is different from the substrate main body 50. The lyophilic portion 52 may include a concave portion formed in the substrate main body 50 by etching or cutting, for example. A lyophilic process of assigning the lyophilic property to the substrate main body 50 may be surface processing of exposing a surface to be processed to oxygen plasma, for example, or may be surface processing of assigning a hydroxyl group (—OH) to the surface to be processed.

The liquid-repellent property of the surface of the second liquid-repellent portion 53 with respect to the first cleaning liquid LC1 is higher than the liquid-repellent property of the surface of the lyophilic portion 52 with respect to the first cleaning liquid LC1. Further, in the present embodiment, the liquid-repellent property of the surface of the second liquid-repellent portion 53 with respect to the second cleaning liquid LC2 is higher than the liquid-repellent property of the surface of the lyophilic portion 52 with respect to the second cleaning liquid LC2. The second liquid-repellent portion 53 may be liquid-repellent to the first cleaning liquid LC1, or may be lyophilic to the first cleaning liquid LC1. Further, the second liquid-repellent portion 53 may be liquid-repellent to the second cleaning liquid LC2, or may be lyophilic to the second cleaning liquid LC2. The contact angle of the first cleaning liquid LC1 with respect to the first liquid-repellent portion 51 may be the same as or may be different from the contact angle of the first cleaning liquid LC1 with respect to the second liquid-repellent portion 53. The contact angle of the second cleaning liquid LC2 with respect to the first liquid-repellent portion 51 may be the same as or may be different from the contact angle of the second cleaning liquid LC2 with respect to the second liquid-repellent portion 53. In the present embodiment, the respective contact angles of the first cleaning liquid LC1 and the second cleaning liquid LC2 with respect to the second liquid-repellent portion 53 are approximately the same as the respective contact angles of the first cleaning liquid LC1 and the second cleaning liquid LC2 with respect to the first liquid-repellent portion 51. The second liquid-repellent portion 53 may include a liquid-repellent member in a similar way to the first liquid-repellent portion 51, or may include a part of the substrate main body 50 which undergoes the liquid-repellent process. The materials of the liquid-repellent members may be the same or may be different from each other, in the first liquid-repellent portion 51 and the second liquid-repellent portion 53. The second liquid-repellent portion 53 in the present embodiment has substantially the same liquid-repellent property as the liquid-repellent property of the liquid-repellent portion 24 of the liquid immersion member 7 to the first cleaning liquid LC1. The second liquid-repellent portion 53 in the present embodiment has the same material as the material of the liquid-repellent portion 24 of the liquid immersion member 7.

The first liquid-repellent portion 51 according to the present embodiment has a shape and a size which are set so that the opening 7K of the liquid immersion member 7 is accommodated inside the outer periphery thereof. For example, as relative positions of the liquid immersion member 7 and the first liquid-repellent portion 51 are adjusted as necessary, the shape and the size of the first liquid-repellent portion 51 are set so that the opening 7K can be accommodated inside the outer periphery of the first liquid-repellent portion 51 when seen from a planar view in a plate thickness direction of the liquid immersion member 7 (Z axis direction) (hereinafter, referred to as a planar view). The first liquid-repellent portion 51 in the present embodiment is a region surrounded by its outer periphery. In the present embodiment, the region surrounded by the outer periphery of the first liquid-repellent portion 51 is larger than the opening 7K of the liquid immersion member 7. In the present embodiment, the region surrounded by the outer periphery of the first liquid-repellent portion 51 is smaller than a region surrounded by the liquid recovery port 20 in the lower surface 14 of the liquid immersion member 7. Here, the region surrounded by the outer periphery of the first liquid-repellent portion 51 may be larger than the region surrounded by the liquid recovery port 20 in the lower surface 14 of the liquid immersion member 7. The region surrounded by the outer periphery of the first liquid-repellent portion 51 may have the same size as the region surrounded by the liquid recovery port 20 in the lower surface 14 of the liquid immersion member 7.

The outer periphery of the first liquid-repellent portion 51 may have the same size as the appearance of the lower surface 15B of the plate section 15. Further, the region surrounded by the first liquid-repellent portion 51 may have the same size as the region surrounded by the appearance of the lower surface 15B of the plate section 15. Further, the outer periphery of the first liquid-repellent portion 51 may be larger or smaller than the appearance of the lower surface 15B of the plate section 15. Further, the region surrounded by the first liquid-repellent portion 51 may be broader or narrower than the appearance of the lower surface 15B of the plate section 15.

The region which faces the opening 7K of the liquid immersion member 7 in the cleaning substrate CP is changed according to the relative positions between the liquid immersion member 7 and the cleaning substrate CP. That is, the region which faces the opening 7K of the liquid immersion member 7 is determined according to the position of the opening 7K. For example, in the positioning state of FIGS. 5A and 5B, the region which faces the opening 7K of the liquid immersion member 7 in the cleaning substrate CP is an inner side 51a of the first liquid-repellent portion 51. In the positioning state of FIGS. 5A and 5B, the region which faces the opening 7K of the liquid immersion member 7 may be surrounded by the outer periphery of the first liquid-repellent portion 51. Further, in the positioning state of FIGS. 5A and 5B, the outer periphery of the first liquid-repellent portion 51 of the cleaning substrate CP faces the lower surface 15B.

The lyophilic portion 52 is disposed to surround the first liquid-repellent portion 51. The lyophilic portion 52 in the present embodiment surrounds the first liquid-repellent portion 51 in an annular shape. In the present embodiment, the shape and the size of the lyophilic portion 52 are set so that at least a part of the liquid recovery port 20 of the liquid immersion member when seen from a planar view in the positioning state is overlapped with the lyophilic portion 52. In FIGS. 5A and 513, in a diametrical direction (for example, A-A′) of the cleaning substrate CP, the lyophilic portion 52 is larger than the liquid recovery port 20 of the liquid immersion member 7. In the present embodiment, in the positioning state, the shape and the size of the lyophilic portion 52 are set so that the entirety of the second supply port 22 faces the lyophilic portion 52. In the cleaning sequence according to the present embodiment, in the positioning state of FIGS. 5A and 5B, flowing of the liquids (LC1, LC2 and LH) to the first liquid-repellent portion 51 from the lyophilic portion 52 is suppressed. In the present embodiment, when the first liquid-repellent portion 51 is disposed to surround the optical path K and the liquids (LC1, LC2 and LH) are supplied between the liquid immersion member 7 and the lyophilic portion 52, the liquids (LC1, LC2 and LH) is suppressed from passing through the opening 7K. That is, in the present embodiment, since the liquid (LC1, LC2 and LH) supplied between the liquid immersion member 7 and the lyophilic portion 52 is suppressed from flowing to a space between the liquid immersion member 7 and the first liquid-repellent portion 51, the liquid (LC1, LC2 and LH) is suppressed from flowing to a space (space on the side of the upper surface 15A) on the upper side of the opening 7K from a space (space on the side of the lower surface 15B) on the lower side of the opening 7K.

The second liquid-repellent portion 53 is disposed to surround the lyophilic portion 52. The second liquid-repellent portion 53 in the present embodiment surrounds the lyophilic portion 52 in an annular shape. In the present embodiment, the shape and the size of the second liquid-repellent portion 53 are set so that the second liquid-repellent portion 53 when seen from a planar view in the positioning state does not face the second supply port 22. In the present embodiment, the shape and the size of the second liquid-repellent portion 53 are set so that at least a part of the second liquid-repellent portion 53 when seen from a planar view in the positioning state faces the liquid-repellent portion 24 of the liquid immersion member 7.

The notches 55a to 55c in the present embodiment are provided to be associated with a non-exposure operation of the exposure apparatus EX. In the present embodiment, at least one of the number of notches 55a to 55c, the respective shapes of the notches 55a to 55c, and the respective positions of the notches 55a to 55c in the outer periphery portion 54 of the cleaning substrate CP is set according to the non-exposure operation of the exposure apparatus EX. The respective shapes of the notches 55a to 55c may be the same or may be different from each other. The cleaning substrate CP may include a notch for position detection which indicates a position in the cleaning substrate C. The notch for position detection may be disposed in an azimuth or a position associated with a crystalline direction of the substrate, for example. The notches 55a to 55c may be separately provided with respect to the notch for position detection, or may include the notch for position detection.

In the present embodiment, in the outer periphery portion of the cleaning substrate CP, the notches are set according to the non-exposure operation of the exposure apparatus EX, but the set cleaning substrate CP is not limited to the substrate according to the present embodiment. For example, as the substrate used for the non-exposure operation, a substrate having only one type of liquid-repellent portion may be used. Thus, it is possible to match the notch detection result (which will be described later) and the non-exposure operation. Further the cleaning substrate CP in the present embodiment may include only the notch for position detection, or may not include any notch. Further, the cleaning substrate CP may include an identifier associated with the non-exposure operation of the exposure apparatus EX, and the identifier may be different from the notch. The identifier may be a barcode. Further, the dummy substrate according to this embodiment may be applied to a dummy substrate used for the non-exposure operation other than cleaning. That is, in the dummy substrate, a notch associated with the non-exposure operation other than cleaning may be disposed in an outer periphery portion thereof. Accordingly, it is possible to match the notch detection result and the non-exposure operation.

The substrate main body 50 in the present embodiment uses a silicon substrate as a base. The first liquid-repellent portion 51 in the present embodiment includes a plate member (liquid-repellent member) of polytetrafluoroethylene. According to a gap between the lower surface 14 and the cleaning substrate CP when the lower surface 14 of the liquid immersion member 7 faces the cleaning substrate CP, the thickness of the plate member of the first liquid-repellent portion 51 may be set. The second liquid-repellent portion 53 according to the present embodiment includes a plate member (liquid-repellent member) of polytetrafluoroethylene. The lyophilic portion 52 in the present embodiment includes the substrate main body 50 between the first liquid-repellent portion 51 and the second liquid-repellent portion 53.

In the present embodiment, the surface of the first liquid-repellent portion 51 and the surface of the lyophilic portion 52 has a step difference according to the thickness of the liquid-repellent member and the lyophilic member. In a case where the lyophilic portion 52 includes the concave part formed in the substrate main body 50, the step difference described above becomes a step difference according to the thickness of the liquid-repellent member and the depth of the concave part. The first liquid-repellent portion 51 according to the present embodiment is more protruded than the lyophilic portion 52 in the plate thickness direction (vertical direction) of the substrate main body 50. The first liquid-repellent portion 51 according to the present embodiment forms a convex portion with respect to the lyophilic portion 52, outward from the substrate main body 50. In the present embodiment, in the Z axis direction of FIG. 5B, the interval between the first liquid-repellent portion 51 and the lower surface 15B is shorter than the interval between the lyophilic portion 52 and the lower surface 15B.

In the present embodiment, the surface of the second liquid-repellent portion 53 and the surface of the lyophilic portion 52 form a step difference according to the thicknesses of the liquid-repellent member and the lyophilic member. In a case where the lyophilic portion 52 includes the concave part formed in the substrate main body 50, the step difference described above becomes a step difference according to the thickness of the liquid-repellent member and the depth of the concave part. The second liquid-repellent portion 53 according to the present embodiment is more protruded than the lyophilic portion 52 in the plate thickness direction of the substrate main body 50. The second liquid-repellent portion 53 according to the present embodiment forms a convex portion with respect to the lyophilic portion 52, outward from the substrate main body 50. In the present embodiment, the step difference between the first liquid-repellent portion 51 and the lyophilic portion 52 and the step difference between the lyophilic portion 52 and the second liquid-repellent portion 53 are set in a range of 0.03 mm or more and 0.3 mm or less.

The step difference between the surface of the first liquid-repellent portion 51 and the surface of the lyophilic portion 52 may be different from the step difference between the surface of the second liquid-repellent portion 51 and the surface of the lyophilic portion 52.

In the region inside the outer periphery of the first liquid-repellent portion 51, a portion having a liquid-repellent property different from that of the first liquid-repellent portion 51 may be disposed. For example, the first liquid-repellent portion 51 may be disposed in an annular shape, and a liquid-repellent or non-liquid-repellent portion may be included in a portion surrounded by the first liquid-repellent portion. The non-liquid-repellent property includes a lyophilic property. The cleaning substrate CP may include a lyophilic portion which is more lyophilic than the first liquid-repellent portion 51 with respect to the first cleaning liquid CL1, in the portion surrounded by the first liquid-repellent portion 51. The cleaning substrate CP may not include the second liquid-repellent portion 53. Further, the shape of the outer periphery of the first liquid repellent portion 51 is not limited to the rectangular shape. The outer periphery of the first liquid-repellent portion 51 may be any one of a circular shape, an elliptical shape, a polygonal shape, a shape in which some corners of the polygonal shape are rounded, a shape having an outline of a free curve, and a combined shape of these shapes. Further, the step difference may not be present between the first liquid-repellent portion 51 and the lyophilic portion 52. Further, the step difference may not be present between the lyophilic portion 52 and the second liquid-repellent portion 53.

Further, for example, by allowing a part of the liquid recovery port 20 when seen from a planar view in the positioning state to face the lyophilic portion 52 and by changing the relative positions between the liquid immersion member 7 and the cleaning substrate CP, the portions of the liquid recovery ports 20 may sequentially face the lyophilic portion 52. For example, by rotating the cleaning substrate CP around the Z axis in the positioning state, the entire portions of the liquid recovery port 20 may face the lyophilic portion 52 in a time series manner while maintaining the positioning state.

Further, the lyophilic portion may be present between the first liquid-repellent portion 51 and the second liquid-repellent portion 53. For example, the liquid-repellent portion which extends in a radial direction from the center of the cleaning substrate CP between the first liquid-repellent portion 51 and the second liquid-repellent portion may be disposed around the first liquid-repellent portion 51. In this case, the liquid-repellent portion which extends in the radial direction between the first liquid-repellent portion 51 and the second liquid-repellent portion may be connected to at least one of the first liquid-repellent portion 51 and the second liquid-repellent portion, or may not be connected thereto.

Further, the second liquid-repellent portion 53 of the cleaning substrate CP may not be formed. In this case, for example, the liquid (including at least one of the first cleaning liquid LC1, the second cleaning liquid LC2 and the rinse liquid LH) flowing out of the upper surface of the cleaning substrate CP may flow into a lower space through a gap between the cover member T and the cleaning substrate CP. In this case, for example, it is possible to clean at least a part of at least one of the cover member T and the substrate holding section 11, using the liquid (including at least one of the first cleaning liquid LC1, the second cleaning liquid LC2 and the rinse liquid LH) flowing in through the gap.

The plurality of lyophilic portions 52 may be disposed around the first liquid-repellent portion 51, and the plurality of lyophilic portions 52 may be arranged in a circumferential direction around the optical axis 12A to surround the first liquid-repellent portion 51. Further, the respective contact angles of the plurality of lyophilic portions with respect to water may be different.

Further, for example, by allowing a part of the second supply port 22 when seen from a planar view in the positioning state to face the second-repellent portion 53, and by changing the relative positions between the liquid immersion member 7 and the cleaning substrate CP, the second supply port 22 may not face the second liquid repellent portion 53. For example, by rotating the cleaning substrate CP around the Z axis in the positioning state, it is possible to exchange a state where the second supply port 22 faces the second liquid-repellent portion 53 and a state where the second supply port 22 does not face the second liquid-repellent portion 53 while maintaining the positioning state.

Further, the second liquid-repellent portion 53 and the lyophilic portion 52 may be non-continuous, and the liquid-repellent property of the cleaning substrate CP with respect to the cleaning liquid LC may be changed in a step-by-step or continuous manner between the second liquid-repellent portion 53 and the lyophilic portions 52.

The dummy substrate may be a substrate used for a non-exposure operation which uses a liquid other than the cleaning liquid LC. This liquid may be the exposure liquid LQ. The dummy substrate may be a substrate used for the non-exposure operation other than cleaning. For example, the dummy substrate may be a substrate used for the measurement operation of the exposure apparatus EX. The dummy substrate may be a substrate used for an operation of checking a variety of sensors included in the exposure apparatus EX.

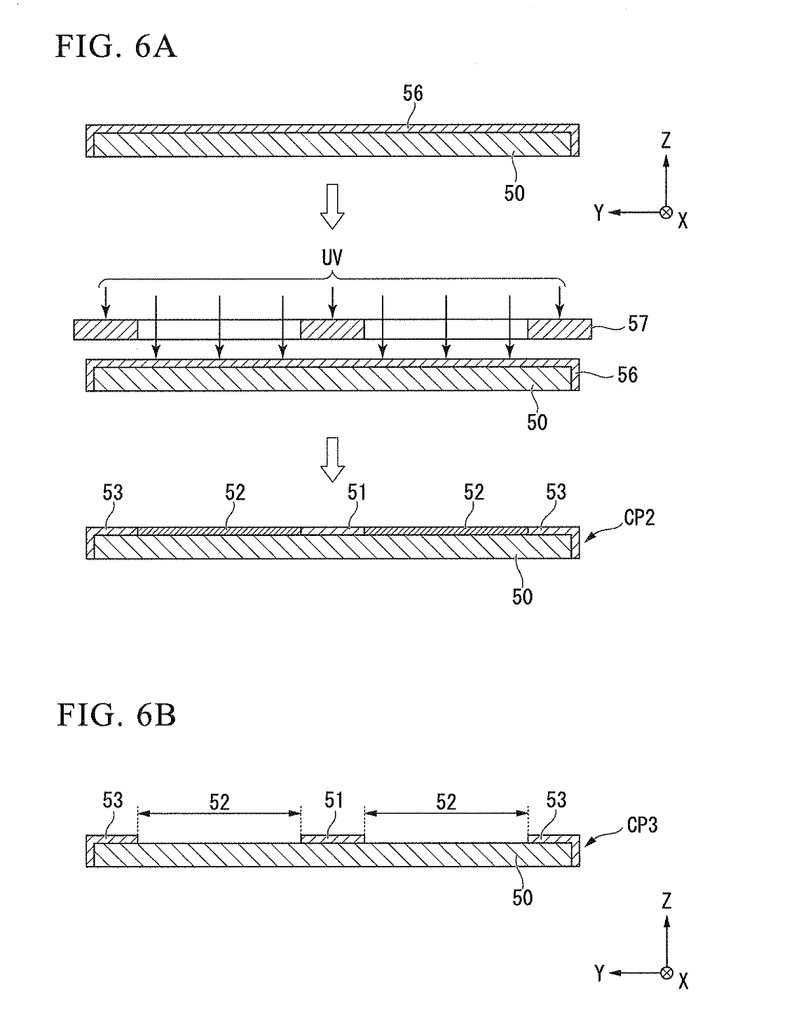

FIGS. 6A and 6B are configuration diagrams schematically illustrating a different example of the cleaning substrate according to the second embodiment, respectively.

A cleaning substrate CP2 shown in FIG. 6A includes the substrate main body 50, the first liquid-repellent portion 51, the lyophilic portion 52 and the second liquid-repellent portion 53. In the cleaning substrate CP2 according to the present embodiment, the surface of the first liquid-repellent portion 51 and the surface of the lyophilic portion 52 are substantially the same surface. In the cleaning substrate CP2 according to the present embodiment, the surface of the first liquid-repellent portion 51 and the surface of the lyophilic portion 52 are substantially the same surface. The cleaning substrate CP2 according to the present embodiment is manufactured according to the flow shown in FIG. 6A, for example. The manufacturing method of the cleaning substrate CP2 in the present embodiment includes preparing the substrate main body 50 in which a liquid-repellent film 56 is formed on the surface thereof, selectively irradiating the liquid-repellent film 56 with light to reduce the liquid-repellent property (improve the lyophilic property) of a region irradiated with the light. In the present embodiment, by forming the liquid-repellent film 56 with the above-described liquid-repellent material on the surface of the substrate main body 50, the substrate main body 50 in which the liquid-repellent film 56 is formed on the surface thereof is prepared. In the present embodiment, the liquid-repellent film 56 is formed by the liquid-repellent material including polytetrafluoroethylene (PFA). In the present embodiment, the liquid-repellent film 56 is irradiated with ultraviolet light UV via the photomask 57, and a portion of the liquid-repellent film 56 irradiated with the ultraviolet light UV is used as the lyophilic portion 52. A photomask 57 in the present embodiment includes an annular light transmitting portion and a light shielding portion disposed inside and outside the light transmitting portion. In the present embodiment, a portion of the liquid-repellent film 56 which is not irradiated with the ultraviolet light UV corresponding to the inside of the light transmitting portion of the photomask 57 is used as the first liquid-repellent portion 51. In the present embodiment, the portion of the liquid-repellent film 56 which is not irradiated with the ultraviolet light UV corresponding to the outside of the light transmitting portion of the photomask 57 is used as the first liquid-repellent portion 53.

A cleaning substrate CP3 shown in FIG. 6B includes the substrate main body 50, the first liquid-repellent portion 51, the lyophilic portion 52 and the second liquid-repellent portion 53. In the present embodiment, the liquid-repellent property of the surface of the substrate main body 50 is lower than the liquid-repellent property of the surface of the first liquid-repellent portion 51. The substrate main body 50 according to the present embodiment is a titanium substrate. The substrate main body 50 may be a silicon substrate. The lyophilic portion 52 according to the present embodiment includes a surface of the substrate main body 50. In the cleaning substrate CP3, the surface disposed to face the liquid immersion member 7 when the cleaning is performed may be irradiated with ultraviolet light before the cleaning is performed. The ultraviolet light may be light emitted from the same light source as the exposure light EL. The ultraviolet light may be light emitted from a light source which is different from the exposure light EL. The substrate main body 50 may include a surface made of material which is larger than the first liquid-repellent portion 51 in the reduction amount of the liquid-repellent property when being irradiated with the ultraviolet light.

### Third Embodiment

A third embodiment will now be described. In the present embodiment, the control device 8 of the exposure apparatus EX controls the liquid system 100, to thereby supply and recover of a variety of liquids used for cleaning is performed. In the present embodiment, the control device 8 is capable of controlling some or all of the valves 35 to 37, the diluting device 38, the first cleaning liquid supply device 39, the second cleaning liquid supply device 40, the suction device 41, and the detection device 42 which form the liquid system 100.

In the present embodiment, the control device 8 of the exposure apparatus EX controls the liquid system 100, to thereby supply and recover of a variety of liquids used for cleaning is performed. In the present embodiment, the control device 8 is capable of controlling some or all of the valves 35 to 37, the diluting device 38, the first cleaning liquid supply device 39, the second cleaning liquid supply device 40, the suction device 41, and the detection device 42 which form the liquid system 100.

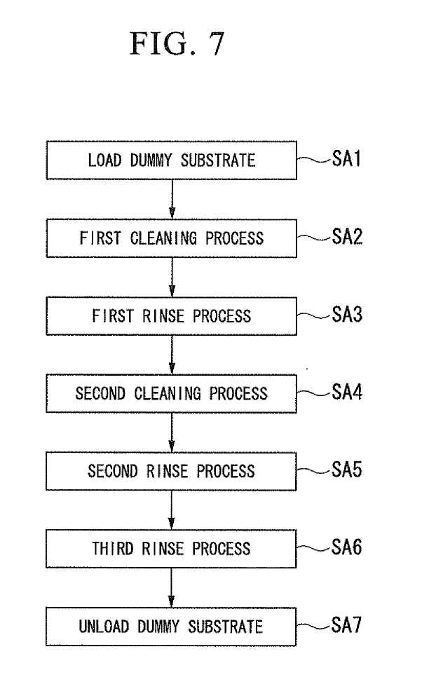

FIG. 7 is a flowchart illustrating an example of a cleaning method according to the present embodiment. In the cleaning method of the present embodiment, the cleaning substrate CP is loaded to the substrate stage 2 in step SA1. In step SA2, the first cleaning liquid LC1 for cleaning is supplied between the liquid immersion member 7 and the cleaning substrate CP, to thereby clean the liquid immersion member 7. In step SA3, the rinse liquid LH for rinse is supplied to the liquid immersion member 7. In step SA4, the second cleaning liquid LC2 for cleaning is supplied between the liquid immersion member 7 and the cleaning substrate CP, to thereby clean the liquid immersion member 7. In step SA5, the rinse liquid LH for rinse is supplied to the liquid immersion member 7. After at least a part of the rinse liquid LH supplied in step SA5 is recovered, the rinse liquid LH is supplied to the liquid immersion member 7 in step SA6. In step SA7, the cleaning substrate CP is unloaded from the substrate stage 2.

In the following description, the cleaning process (SA2) which uses the first cleaning liquid LC1 is appropriately referred to as a first cleaning process, and the cleaning process (SA4) which uses the second cleaning liquid LC2 is appropriately referred to as a second cleaning process. A process of supplying the rinse liquid LH to a member such as a liquid immersion member 7 which is cleaned using the cleaning liquid LC (LC1 and LC2) is appropriately referred to as a rinse process. The rinse process includes a process of supplying the rinse liquid LH to the member to clean the member and removing the cleaning liquid LC (LC1 and LC2) which remains in the member. The rinse process (SA3) which is performed after the first cleaning process is appropriately referred to as a first rinse process, the rinse process (SA5) which is performed after the second cleaning process is appropriately referred to as a second rinse process, and the rinse process (SA6) which is performed after the second rinse process is appropriately referred to as a third rinse process.

An alkaline liquid may be used as the first cleaning liquid LC1. That is, an alkaline solution including a predetermined substance may be used as the first cleaning liquid LC1. For example, the first cleaning liquid LC1 may include tetramethyl ammonium hydroxide (TMAH) as the predetermined substance. Further, an alkaline aqueous solution may be used as the first cleaning liquid LC1.

An acid liquid may be used as the second cleaning liquid LC2. That is, an acid solution including a predetermined substance may be used as the second cleaning liquid LC2. For example, the second cleaning liquid LC2 may include hydrogen peroxide as the predetermined substance. Further, an acid aqueous solution may be used as the second cleaning liquid LC2.

An aqueous solution may be used as the rinse liquid LH. That is, an aqueous solution which includes a predetermined substance may be used as the rinse liquid LH. The predetermined substance may not be included. Alcohol may be included as the predetermined substance. Further, alcohol may be used as the rinse liquid. Further, the first cleaning liquid LC1 and the rinse liquid LH may include the same type of liquid. Further, the second cleaning liquid LC2 and the rinse liquid LH may include the same type of liquid.

In the present embodiment, an alkaline aqueous solution is used as the first cleaning liquid LC1. A hydrogen peroxide aqueous solution is used as the second cleaning liquid LC2. The exposure liquid LQ is used as the rinse liquid LH. That is, the rinse liquid LH in the present embodiment is water (pure water). Each of the first cleaning liquid LC1, the second cleaning liquid LC2 and the rinse liquid LH in the present embodiment includes water as the same type of liquid.

In the present embodiment, a tetramethyl ammonium hydroxide aqueous solution is used as the first cleaning liquid LC1. An inorganic alkaline solution such as ammonia water, sodium hydroxide solution or potassium hydroxide solution, or an organic alkaline solution such as trimethyl (2-hydroxylethyl) ammonium hydroxide, may be used as the first cleaning liquid.

In the present embodiment, the hydrogen peroxide aqueous solution (hydrogen peroxide water) is used as the second cleaning liquid LC2. The second cleaning liquid LC2 may include a buffered hydrofluoric acid solution. Further, the second cleaning liquid LC2 may be a solution including buffered hydrofluoric acid and hydrogen peroxide. The buffered hydrofluoric acid is a mixture of hydrofluoric acid and ammonium fluoride. The mixing ratio may be 5 to 2,000 in a volume ratio of an ammonium fluoride solution of 40 weight % to hydrofluoric acid of 50 weight %. Further, the mixing ratio of buffered hydrofluoric acid and hydrogen peroxide may be 0.8 to 55 in a weight ratio of hydrogen peroxide to hydrofluoric acid. An ozone liquid including ozone or a mixed solution of hydrogen peroxide and a solution including ozone may be used as the second cleaning liquid LC2.

At least one of the first cleaning liquid LC1 and the second cleaning liquid LC2 may include alcohol. For example, at least one of the first cleaning liquid LC1 and the second cleaning liquid LC2 may include at least one of ethanol, isopropyl alcohol (IPA), and pentanol. Further, the same type of liquid included in each of the first cleaning liquid LC1 and the second cleaning liquid LC2 may be alcohol, for example. Further, at least one of the first cleaning liquid LC1, the second cleaning liquid LC2 and the rinse liquid LH may be supplied in a state where at least one of the upper surface 2F of the substrate stage 2 and the upper surface 3F of the measurement stage 3 is disposed to face the liquid immersion member 7, or may be supplied in a state where an object which is different from the cleaning substrate CP, the dummy substrate, the substrate stage 2 and the measurement stage 3 is disposed.

Further, in a case where the first cleaning liquid LC1, the second cleaning liquid LC2 and the rinse liquid LH are supplied to clean the terminal optical device 12 and the liquid immersion member 7, the object (the cleaning substrate CP, the substrate stage 2, the measurement stage 3, the dummy substrate or the like) which faces the liquid immersion member 7 may be changed in each of the first cleaning liquid LC1, the second cleaning liquid LC2 and the rinse liquid LH. Further, in a case where the liquid immersion member 7 is cleaned using the cleaning substrate CP or the like, the type of the cleaning substrate CP or the like may be changed for cleaning in each of the first cleaning liquid LC1, the second cleaning liquid LC2 and the rinse liquid LH.

Further, in each of the first cleaning liquid LC1, the second cleaning liquid LC2 and the rinse liquid LH, the cleaning substrate CP or the like may be changed to a cleaning substrate CP or the like of the same type. For example, after completion of the cleaning in the first cleaning liquid LC1, or in the middle of the cleaning in the first cleaning liquid LC1, the cleaning substrate CP or the like may be changed to a new cleaning substrate CP of the same type to perform cleaning.

In step SA1 according to the present embodiment, the control device 8 performs a process of loading the cleaning substrate CP to the substrate stage 2. In order to load the cleaning substrate CP to the substrate stage 2 (substrate holding section 11), the control device 8 moves the substrate stage 2 to the substrate exchange position.

In a case where the substrate P is held by the substrate holding section 11, after the process of unloading the substrate P from the substrate stage 2 is performed, the process of loading the cleaning substrate CP to the substrate holding section 11 is performed. In the present embodiment, in a case where the substrate stage 2 is disposed in the substrate exchange position to load the cleaning substrate CP, the measurement stage 3 is disposed in a position which faces the terminal optical device 12 and the liquid immersion member 7. In order to recover all the exposure liquid LQ in the liquid immersion space LS formed between the terminal optical device 12 and the liquid immersion member 7, and the measurement stage 3, the control device 8 performs the recovery of the exposure liquid LQ for predetermined period of time through the liquid recovery port 20 (holes 19H of the porous member 19) in a state where the supply of the exposure liquid LQ through the first supply port 21 is stopped.

In a case where all the exposure liquid LQ in the liquid immersion space LS is recovered, an object which is different from the measurement stage 3 may be disposed in the position which faces the terminal optical device 12 and the liquid immersion member 7. For example, in a state where the exposure liquid LQ is held between the terminal optical device 12 and the liquid immersion member 7, and the cleaning substrate CP (or substrate stage 2) which is loaded to the substrate stage 2, the supply of the exposure liquid LQ through the first supply port 21 may be stopped and the recovery of the exposure liquid LQ through the liquid recovery port 20 may be performed for a predetermined time. Further, after the supply of the exposure liquid LQ is stopped, when the first cleaning process is performed, the exposure liquid LQ which remains in the first interior liquid passage 21R may be removed.

In step SA1 according to the present embodiment, the notches 55a to 55c of the cleaning substrate CP are detected. The notches 55a to 55c may be optically detected, or may be detected through contact with probes or the like. When the notches 55a to 55c are optically detected, an imaging device which images the notches 55a to 55c may be used, or a detection system which detects light passing through the notches 55a to 55c may be used. A notch detection device or a notch detection method which detects the notches can employ a device or a method disclosed in Japanese patent application publication number 63-266850, for example.

In the present embodiment, the device manufacturing system including the exposure apparatus EX includes the notch detection device which detects the notches 55a to 55c. The exposure apparatus EX may have a part or the entirety of the notch detection device. The detection result of the notch detection device is matched with a scheduled operation of the exposure apparatus EX. In the present embodiment, the control device 8 of the exposure apparatus EX matches the detection result of the detection device and the scheduled operation of the exposure apparatus EX. In the present embodiment, correspondence information indicating the correspondence relationship between notch information and a variety of operations of the exposure apparatus EX is stored in a storing section. The storing section may be a part of the control device 8 or may be an external device with respect to the control device 8. When performing the matching, the control device 8 obtains the correspondence information and compares the information with the detection result of the notch detection device. An external device with respect to the exposure apparatus EX, which is a part of the device manufacturing system, may perform the matching.

A method of detecting information relating to the non-exposure operation of the cleaning substrate CP is not limited to the notches. For example, information relating to distribution of the liquid-repellent portion may be printed in the cleaning substrate CP. In this case, it is preferable to provide a detection device for extracting the information printed in the cleaning substrate CP. Thus, the information relating to the distribution of the liquid-repellent portion in the cleaning information CP can be matched from the printed portion as well as the notches. As the printed portion, a barcode identified by the thickness of a line of a stripe pattern is used, for example.

In the present embodiment, the control device 8 determines whether a substrate before being held by the substrate stage 2 or a substrate after being held by the substrate stage 2 is a substrate corresponding to the non-exposure operation scheduled in the exposure apparatus EX. The non-exposure operation includes one or more of the measurement operation of the substrate, the cleaning operation of the exposure apparatus EX, and other maintenance operations of the exposure apparatus EX, for example.

The detection result of the detection device may be displayed on a display panel or the like, and a user may perform the above-described determination. Further, the external device with respect to the exposure apparatus EX which is a part of the device manufacturing system may perform the above-described determination. The control device 8 may notify the user of the determination result. In a case where the substrate before being held by the substrate stage 2 or the substrate after being held by the substrate stage 2 is a substrate which does not correspond to the non-exposure operation scheduled in the exposure apparatus EX, the control device 8 may stop the scheduled operation.

In step SA1 according to the present embodiment, when it is determined that the substrate which is held by the substrate stage 2 is the cleaning substrate CP, the control device 8 continues the cleaning operation. In step SA1 according to the present embodiment, the relative positions of the liquid immersion member 7 and the cleaning substrate CP are adjusted so that the opening 7K of the liquid immersion member 7 is accommodated inside the outer periphery of the first liquid-repellent portion 51 of the cleaning substrate CP when seen from a planar view in the Z axis direction (see FIGS. 5A and 5B). In this case, at least a part of the outer periphery of the first liquid-repellent portion 51 of the cleaning substrate CP faces the lower surface 15B of the liquid immersion member 7.

In the present embodiment, the control device 8 controls the position of the substrate stage 2, to adjust the relative positions of the liquid immersion member 7 and the cleaning substrate CP. In the present embodiment, in the positioning state when seen from a planar view, the entirety of the liquid recovery port 20 of the liquid immersion member 7 and the entirety of the second supply port 22 face the lyophilic portion 52. In the present embodiment, in the positioning state when seen from a planar, at least a part of the liquid-repellent portion 24 of the liquid immersion member 7 faces the second liquid-repellent portion 53. In this state, a space between the liquid repellent portion 24 and the second liquid-repellent portion 53 surrounds a space between the liquid recovery port 20 and the lyophilic portion 52 in an annular shape around the optical axis 12A.

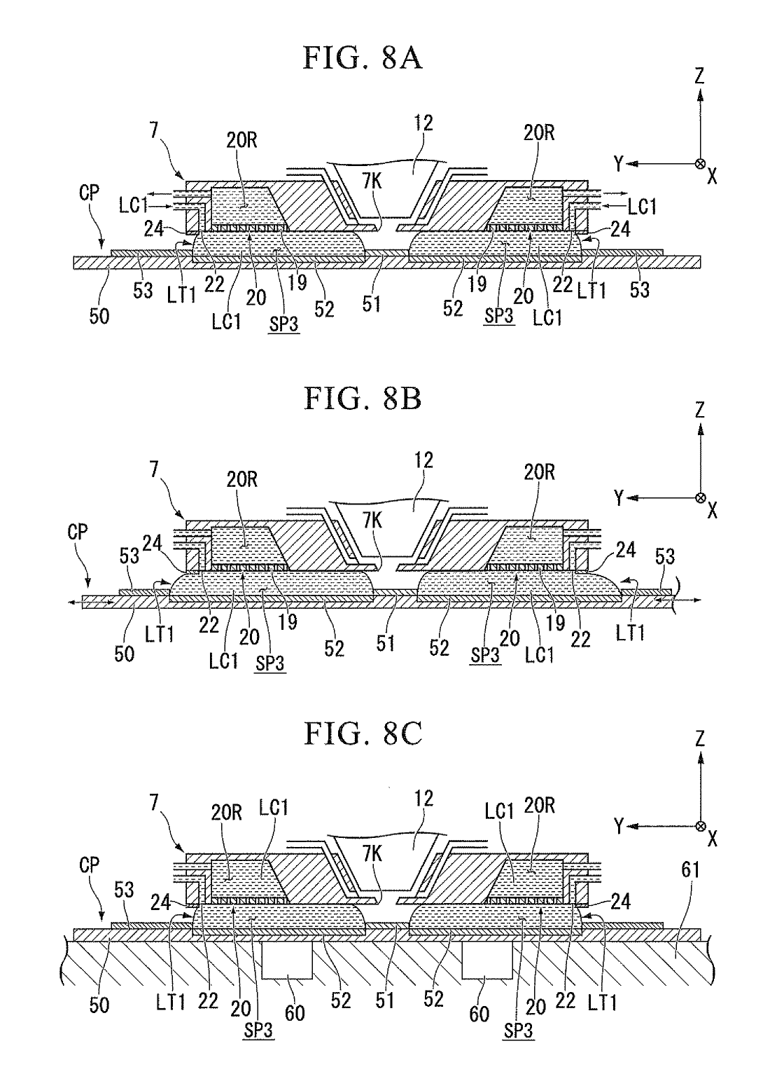

FIGS. 8A, 8B and 8C are diagrams illustrating an example of a state where the first cleaning process is performed. In step SA2 according to the present embodiment, after the exposure liquid LQ of the liquid immersion space LS between the terminal optical device 12 and the liquid immersion member 7, and the object (the substrate stage 2, the measurement stage 3, the dummy substrate or the like) is completely recovered, the first cleaning process is started. In the present embodiment, during at least a part of the period when the first cleaning liquid LC1 is supplied to the space SP3, at least one of the first cleaning liquid LC1 and gas is recovered through the third interior liquid passage 20R.

As shown in FIG. 8A, in the present embodiment, when the supply through the third interior liquid passage 20R is performed, the first cleaning liquid LC1 is supplied to the space SP3. In the present embodiment, in a state where at least a part of the liquid immersion member 7 around the space SP3 is in contact with the first cleaning liquid LC1, the supply of the first cleaning liquid LC1 and the recovery through the third interior liquid passage 20R are stopped. In the present embodiment, in a state where the flow of the first cleaning liquid LC1 is reduced in the space SP3 compared with the time when the supply and recovery of the first cleaning liquid LC1 are performed in parallel, at least a part of the liquid immersion member 7 around the space SP3 is dipped in the first cleaning liquid LC1 for a predetermined time (hereinafter, referred to as a static dipping process). In the present embodiment, the first cleaning liquid LC1 may include alkali, to remove foreign substances including organic substances existing on the surface (surface 14 or the like) of the liquid immersion member 7. In the present embodiment, after the predetermined time elapses, the supply of the first cleaning liquid LC1 is restarted, and the recovery of the first cleaning liquid LC1 is started or restarted through the third interior liquid passage 20R.

In the present embodiment, after the supply of the first cleaning liquid LC1 is stopped at a predetermined timing and the first cleaning liquid LC1 between the liquid immersion member 7 and the cleaning substrate CP is recovered, the first cleaning process is completed. The foreign substances removed from the surface of the liquid immersion member 7 are recovered together with the first cleaning liquid LC1 through the liquid recovery port 20. In the present embodiment, the first cleaning liquid LC1 recovered through the liquid recovery port 20 flows into the containing member 44.

The predetermined timing when the supply of the first cleaning liquid LC1 is stopped may be the time when the supply amount of the first cleaning liquid LC1 reaches a predetermined amount. The predetermined timing may be the time when the recovery amount through the liquid recovery port 20 reaches a predetermined amount. The predetermined timing may be the time when a period of time when the member which becomes a cleaning target is in contact with the first cleaning liquid LC1 reaches a predetermined time. The predetermined timing may be determined on the basis of the detection result of liquid components recovered through the liquid recovery port 20. The predetermined timing may be the time when the amount of the substances removed through the cleaning, which are included in the recovered first cleaning liquid LC1, is equal to or less than a predetermined value. The detection result may be the detection result of the detection device 42 of the liquid system 100.

In the present embodiment, in the first cleaning process, since the first liquid-repellent portion 51 is disposed outside the region which faces the opening 7K, and the lyophilic portion 52 is disposed outside the first liquid-repellent portion 51, a liquid immersion space LT1 is formed by the first cleaning liquid LC1 in at least a part of the space SP3 which is outside the opening 7K. In the present embodiment, it can be expected that the first liquid-repellent portion 51 suppresses the first cleaning liquid LC1 from flowing into the side of the opening 7K from the space SP3. Further, since the first liquid-repellent portion 51 is more protruded than the lyophilic portion 52, it can be expected that the first cleaning liquid LC1 is suppressed from flowing to the side of the opening 7K from the space SP3. That is, it is possible to suppress the first cleaning liquid LC1 from flowing into the opening 7K through the surface (for example, the plate section 15) of the liquid immersion member 7. Further, it is possible to suppress an interface with the liquid immersion member LT1 from being formed in the opening 7K by the first cleaning liquid LC1. Further, it is possible to suppress the first cleaning liquid LC1 from being in contact with the terminal optical device 12 through the opening 7K. Accordingly, in the present embodiment, it is possible to supply the first cleaning liquid LC1 only to the surface of the liquid immersion member 7.

As long as the flow of the first cleaning liquid LC1 into the side of the opening 7K from the space SP3 can be suppressed, the first liquid-repellent portion 51 may not be disposed outside the region which faces the opening 7K. That is, in FIG. 8A, the region may be the same region which faces the opening 7K or may be inside the region which faces the opening 7K. For example, by adjusting the supply amount of the first cleaning liquid LC1 between the liquid immersion member 7 and the cleaning substrate CP and the recovery amount of the first cleaning liquid LC1 between the liquid immersion member 7 and the cleaning substrate CP, it is possible to differentiate the positions of the interface on the side of the liquid immersion member 7 of the liquid immersion space LT1 formed by the first cleaning liquid LC1 and the interface on the side of the cleaning substrate CP thereof. For example, in a state where the interface on the side of the liquid immersion member 7 is maintained on the surface of the liquid immersion member 7, the position of the interface on the side of the cleaning substrate CP can be formed in the region which faces the opening 7K, thereby making it possible to suppress the first cleaning liquid LC1 from flowing into the opening 7K. A region surrounded by the outer periphery of the first liquid-repellent portion 51 may be the same as or may be smaller than the opening 7K of the liquid immersion member 7.

In the present embodiment, since the lyophilic portion 52 is disposed outside the first liquid-repellent portion 51 and the second liquid-repellent portion 53 is disposed outside the lyophilic portion 52, the liquid immersion space LT1 is formed by the first cleaning liquid LC1 in at least a part of the space SP3 which is inside the second liquid-repellent portion 53. In the present embodiment, the second liquid-repellent portion 53 is more protruded than the lyophilic portion 52, it can be expected that the first cleaning liquid LC1 is suppressed from flowing outside the space SP3. In the present embodiment, since the liquid-repellent portion 24 is disposed outside the liquid recovery port 20, it can be expected that the first cleaning liquid LC1 is suppressed from flowing outside the space SP3.

In the present embodiment, the notches 55a to 55c of the cleaning substrate CP disposed to face the liquid immersion member 7 during the first cleaning process are detected. Accordingly, in a state where the substrate which does not correspond to the cleaning operation is mistakenly disposed to face the liquid immersion member 7, it can be expected that the first cleaning liquid LC1 or the like is suppressed from being supplied between the substrate and the liquid immersion member 7.

In step SA2, the static dipping process may not be performed, or two or more static dipping processes may be performed. Before and after the static dipping process, the density of the first cleaning liquid LC1 to be supplied may be changed. Further, the first cleaning liquid LC1 including the exposure liquid LQ may be supplied through the second supply port 22, and at this time, the first cleaning liquid LC1 may be supplied while changing the proportion of the exposure liquid LQ included in the first cleaning liquid LC1. For example, while the first cleaning process is performed, the proportion of the exposure liquid LQ included in the first cleaning liquid LC1 may be gradually or continuously increased or decreased.

Further, during at least one of the time when the first cleaning liquid LC1 is supplied and the time when the supply of the first cleaning liquid LC1 is stopped, vibration may be applied to the first cleaning liquid LC1 between the liquid immersion member 7 and the cleaning substrate CP. By applying vibration to the first cleaning liquid LC1, it can be expected that the first cleaning liquid LC1 is expended to the lyophilic portion 52 or the cleaning ability of the first cleaning liquid LC1 is improved.

In the above description, vibration is applied to the first cleaning liquid LC1 between the liquid immersion member 7 and the cleaning substrate CP, but the first cleaning liquid LC1 to which vibration is applied may be supplied between the liquid immersion member 7 and the cleaning substrate CP. The relative positions of the liquid immersion member 7 and the cleaning liquid CP may be changed.

Further, when the relative positions of the liquid immersion member 7 and the cleaning liquid CP are changed, the relative positions of the liquid immersion member 7 and the cleaning liquid CP may be changed in a direction (Z axis direction) parallel to the optical axis of the projection optical system PL. In this case, the interval between the liquid immersion member 7 (lower surface 15B) and the cleaning substrate CP may be larger or smaller than the interval between the liquid immersion member 7 (lower surface 15B) at the time of exposure and the substrate P. Further, the interval between the liquid immersion member 7 (lower surface 15B) and the cleaning substrate CP and the interval between the liquid immersion member 7 (lower surface 15B) and the substrate P at the time of exposure may be the same. In the present embodiment, the cleaning substrate CP includes the liquid-repellent portion 51, and the interval between the liquid immersion member 7 and the cleaning substrate CP includes the interval between the lower surface 15B of the liquid immersion member 7 and the upper surface of the liquid-repellent portion 51 of the cleaning substrate CP.

Further, when the relative positions of the liquid immersion member 7 and the cleaning substrate CP are changed, the relative positions of the liquid immersion member 7 and the cleaning substrate CP may be changed in a direction (for example, XY plane) which intersects with the optical axis of the projection optical system PL. Further, when the relative positions of the liquid immersion member 7 and the cleaning substrate CP are changed, the relative positions may be changed in a direction (for example, X direction) which intersects with the optical axis of the projection optical system PL while changing the relative positions in the Z axis direction.

Further, when the relative positions of the liquid immersion member 7 and the cleaning substrate CP are changed, a direction where the relative positions are changed may be the same as the direction (Y axis direction) where the relative position of the substrate P with respect to the liquid immersion member 7 at the time of exposure is changed. When the relative positions of the liquid immersion member 7 and the cleaning substrate CP are changed, it is preferable to maintain a state where the lower surface 15B of the liquid immersion member 7 and the outer periphery of the first liquid-repellent portion 51 of the cleaning substrate CP face each other. When the relative positions of the liquid immersion member 7 and the cleaning substrate CP are changed in a direction parallel to the XY plane, the amount of variation of the relative positions may be set so that the opening 7K when seen from a planar view is not moved outside of the first liquid-repellent portion 51. Further, when the opening 7K when seen from a planar view is moved up to the outer periphery of the first liquid-repellent portion 51, for example, the amount of variation of the relative positions may be set according to the size of the liquid repellent portion 24 so that the lyophilic portion 52 is not moved up to the outer periphery beyond the first liquid-repellent portion 24. For example, the size of the liquid-repellent portion 24 in an arbitrary direction in the XY plane may be 0.5 times or more, or one time or more the size of the first liquid-repellent portion 51 in this direction. The arbitrary direction may be the direction where the relative positions of the liquid immersion member 7 and the cleaning substrate CP are changed during the first cleaning process.

Further, in the present embodiment, the liquid-repellent portion 24 is disposed in the liquid immersion member 7, but the liquid-repellent portion 24 may not be disposed in the liquid immersion member 7.

As shown in FIG. 8C, a pressure wave generation device 60 which generates a pressure wave (sound wave and ultra sound wave) may be used, and the generated pressure wave may be directly or indirectly transmitted to the first cleaning liquid LC1. A part or the entirety of the pressure wave generation device 60 may be a part of the exposure apparatus EX or a part of the cleaning substrate CP. The pressure wave generation device 60 may be an external device with respect to the exposure apparatus EX. The pressure wave generation device 60 may be disposed outside the liquid immersion member 7 or may be accommodated in a stage capable of supporting the cleaning substrate CP. The stage 61 may be the substrate stage 2 or the measurement stage 3.

Further, a stirring member which operates according to change in an electric field or a magnetic field may be disposed between the liquid immersion member 7 and the cleaning substrate CP, and vibration may be applied to the first cleaning liquid LC1 according to the operation of the stirring member. A part or the entirety of the stirring member of a drive device which drives the stirring member may be a part of the exposure apparatus EX or the cleaning substrate CP. The stirring member and the drive device may be an external device with respect to the exposure apparatus EX.

In the present embodiment, after the first cleaning process is completed, the first rinse process is started (step SA3). In the present embodiment, after the first cleaning liquid LC1 in the liquid immersion space LT1 is all recovered, the first rinse process is started. In a state where the supply of the first cleaning liquid LC1 through the second supply port 22 is stopped, the control device 8 performs the recovery of the first cleaning liquid LC1 through the liquid recovery port 20 (holes 19H of the porous member 19) for a predetermined time. Thus, the first cleaning liquid LC1 between the terminal optical device 12 and the liquid immersion member 7, and the cleaning substrate CP is mostly all recovered.

In order to recover all the first cleaning liquid LC1, the first cleaning liquid LC1 may be recovered through the second supply port 22, in addition to the recovery operation through the liquid recovery port 20. Further, after the supply of the first cleaning liquid LC1 is stopped, when the first rinse process is performed, the first cleaning liquid LC1 which remains in the second interior liquid passage 22R may be removed. Further, the exposure liquid LQ may be supplied through the second interior liquid passage 22R and the first cleaning liquid LC1 which remains in the second interior liquid passage 22R may be removed.

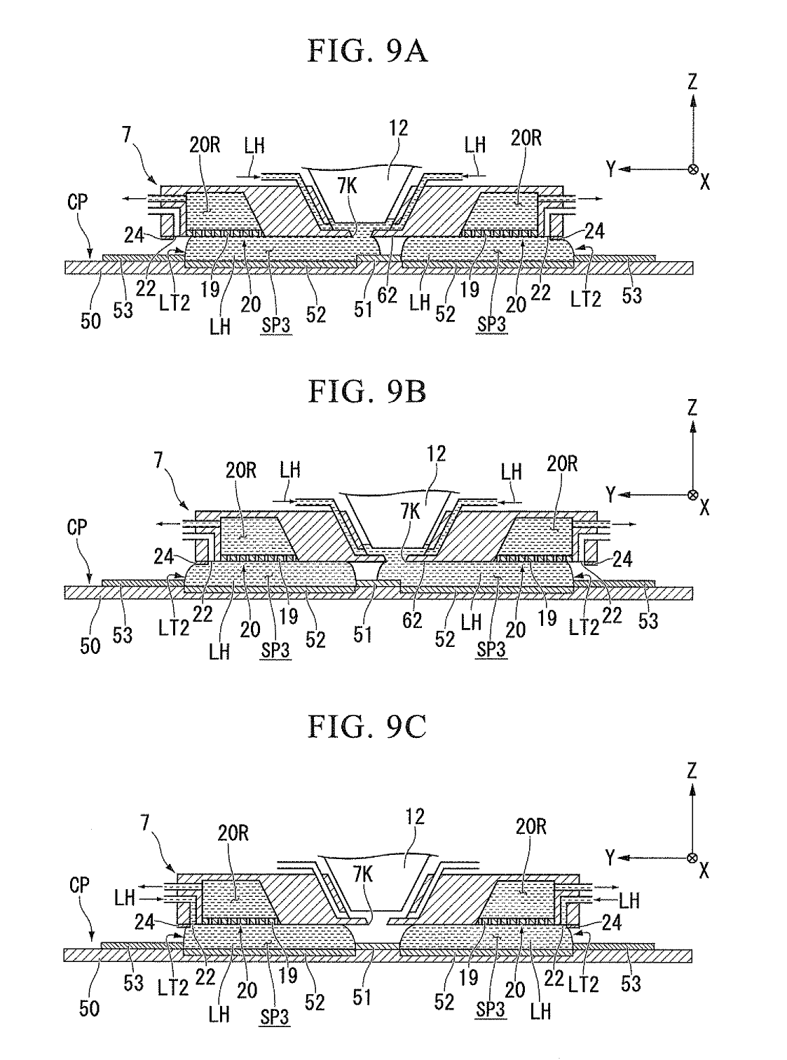

FIGS. 9A, 9B and 9C are diagrams illustrating an example of a state where the first rinse process is performed. In the first rinse process, the cleaning substrate CP is disposed to face the liquid immersion member 7. The control device 8 starts the supply of the rinse liquid LH in order to rinse the liquid immersion member 7 with the rinse liquid LH. In a state where the liquid immersion space LT1 of the first cleaning liquid LC1 is formed, the supply of the rinse liquid LH may be started.

As shown in FIG. 9A, in the present embodiment, the rinse liquid LH is supplied between the liquid immersion member 7 and the lyophilic portion 52 in a state where the relative positions of the opening 7K and the first liquid-repellent portion 51 are different compared with during the supply of the first cleaning liquid LC1 between the lyophilic portion 52 and the liquid immersion member 7. In the present embodiment, after the first cleaning process is completed, the control device 8 adjusts the relative positions of the liquid immersion member 7 and the cleaning substrate CP. In the present embodiment, the relative positions of the liquid immersion member 7 and the cleaning substrate CP are adjusted so that at least a part of the opening 7K when seen from a planar view is disposed outside of the first liquid-repellent portion 51. In the present embodiment, the relative positions of the liquid immersion member 7 and the cleaning substrate CP are adjusted so that at least a part of the opening 7K faces the lyophilic portion 52. In the present embodiment, in a state where the supply of the first cleaning liquid LC1 through the second supply port 22 is stopped, the control device 8 supplies the rinse liquid LH to the space SP1 through the first supply port 21. In the present embodiment, the exposure liquid LQ is used as the rinse liquid LH.

In the first rinse process, the supply of the rinse liquid LH (exposure liquid LQ) through the first supply port 21 and the recovery of the liquid (including at least one of the first cleaning liquid LC1 and the rinse liquid LH) through the liquid recovery port 20 are performed in parallel. Thus, a liquid immersion space LT2 is formed by the rinse liquid LH between the terminal optical device 12 and the liquid immersion member 7, and the cleaning substrate CP. The surface of the liquid immersion member 7 is rinsed by the rinse liquid LH. The rinse liquid LH is capable of removing the first cleaning liquid LC1 which remains on the surface of the liquid immersion member 7. The rinse liquid LH is capable of removing foreign substances attached to the liquid immersion member 7. The liquid recovery port 20 recovers the rinse liquid LH which is supplied to at least a part of the surface of the liquid immersion member 7 through the first supply port 21. The first cleaning liquid LC1 which is removed from the surface of the liquid immersion member 7 is recovered together with the rinse liquid LH through the liquid recovery port 20.

As shown in FIG. 9B, in the present embodiment, even in a state where the relative positions of the liquid immersion member 7 and the cleaning substrate CP are changed compared with the supply starting time of the rinse liquid LH, the rinse liquid LH is supplied. In the present embodiment, the relative positions of the liquid immersion member 7 and the cleaning substrate CP are changed in a direction which intersects with the irradiation direction of the exposure liquid EL. In the present embodiment, the relative positions of the liquid immersion member 7 and the cleaning substrate CP are changed in a direction parallel to the XY plane. In the present embodiment, the relative positions of the liquid immersion member 7 and the cleaning substrate CP are changed so that a portion 62 (see FIG. 9B) of the liquid immersion member 7, which has faced the first liquid-repellent portion 51 at the supply starting time of the rinse liquid LH, faces the lyophilic portion 52. In the present embodiment, the supply of the rinse liquid LH is stopped before the change in the relative positions of the liquid immersion member 7 and the cleaning substrate CP, and the supply of the rinse liquid LH is restarted after the change.

The rinse liquid LH may be supplied while the relative positions of the liquid immersion member 7 and the cleaning substrate CP are changed. In a state where the relative positions in the Z axis direction of the liquid immersion member 7 and the cleaning substrate CP are different compared with during the supply of the first cleaning liquid LC1 between the lyophilic portion 52 and the liquid immersion member 7, the rinse liquid LH may be supplied. In a state where the interval between the liquid immersion member 7 and the cleaning substrate CP are wide compared with during the supply of the first cleaning liquid LC1 between the lyophilic portion 52 and the liquid immersion member 7, the rinse liquid LH may be supplied. Further, vibration may be applied to the rinse liquid LH between the liquid immersion member 7 and the cleaning substrate CP. Using the same device or method used for applying vibration to the first cleaning liquid LC1, vibration may be applied to the rinse liquid LH. As shown in FIG. 9C, the rinse liquid LH may be supplied through the second supply port 22. Between a case where the rinse liquid LH is supplied through the second supply port 22 and a case where the cleaning liquid LC is supplied through the second supply port 22, the relative positions of the liquid immersion member 7 and the cleaning substrate CP may be changed. For example, between a case where the rinse liquid LH is supplied through the second supply port 22 and a case where the cleaning liquid LC is supplied through the second supply port 22, the relative positions in the Z axis direction may be changed. Further, the rinse liquid LH may be supplied through the first supply port 21 and the second supply port 22.

In the present embodiment, the supply of the rinse liquid LH is stopped at a predetermined timing, and then the first rinse process is completed. The predetermined timing when the supply of the rinse liquid LH is stopped may be the time when the supply amount of the rinse liquid LH reaches a predetermined amount. The predetermined timing may be the time when the recovery amount through the liquid recovery port 20 reaches a predetermined amount. The predetermined timing may be the time when a period of time when the member which becomes a cleaning target is in contact with the rinse liquid LH reaches a predetermined time. The predetermined timing may be determined on the basis of the detection result of liquid components recovered through the liquid recovery port 20. The predetermined timing may be the time when the amount of the first cleaning liquid LC1 (density) included in the recovered liquid is equal to or less than a predetermined value. The detection result may be the detection result of the detection device 42 of the liquid system 100. In the present embodiment, until the density of alkali (tetramethyl ammonium hydroxide) included in the rinse liquid LH which is recovered through the liquid recovery port 20 reaches 1% or less, the first rinse process is continued.

In the present embodiment, after the first rinse process is completed, the control device 8 starts the second cleaning process (step SA4). The control device 8 starts the supply of the second cleaning liquid in order to clean the liquid immersion member 7 with the second cleaning liquid LC2.

In the present embodiment, until the supply of the second liquid cleaning liquid LC2 to the liquid immersion member 7 is started, the supply of the rinse liquid LH through the first supply port 21 and the recovery of the rinse liquid LH through the liquid recovery port 20 are performed in parallel. That is, in a state where the liquid immersion space LT2 of the rinse liquid LH is formed, the supply of the second cleaning liquid LC2 is started. After the rinse liquid LH between the terminal optical device 12 and the liquid immersion member 7, and the cleaning substrate CP is all recovered, the supply of the second cleaning liquid LC2 may be started. After the supply of the rinse liquid LH is stopped, when the second cleaning process is performed, the rinse liquid LH which remains in the first interior liquid passage 21R may be removed.

In the present embodiment, in a state where the supply of the rinse liquid LH through the first supply port 21 is stopped, the second cleaning liquid LC2 is supplied to the space SP3 through the first supply port 22. The second cleaning liquid LC2 is supplied in a state where the cleaning substrate CP is disposed to face the liquid immersion member 7. In the present embodiment, in a state where the relative positions of the liquid immersion member 7 and the cleaning substrate CP are adjusted (see FIGS. 5A and 513) so that the opening 7K of the liquid immersion member 7 is accommodated inside the outer periphery of the first liquid-repellent portion 51 of the cleaning substrate CP, the supply of the second cleaning liquid LC2 is started. In the present embodiment, the control device 8 controls the position of the substrate stage 2 to adjust the relative positions of the liquid immersion member 7 and the cleaning substrate CP, and then the supply of the second cleaning liquid is started.

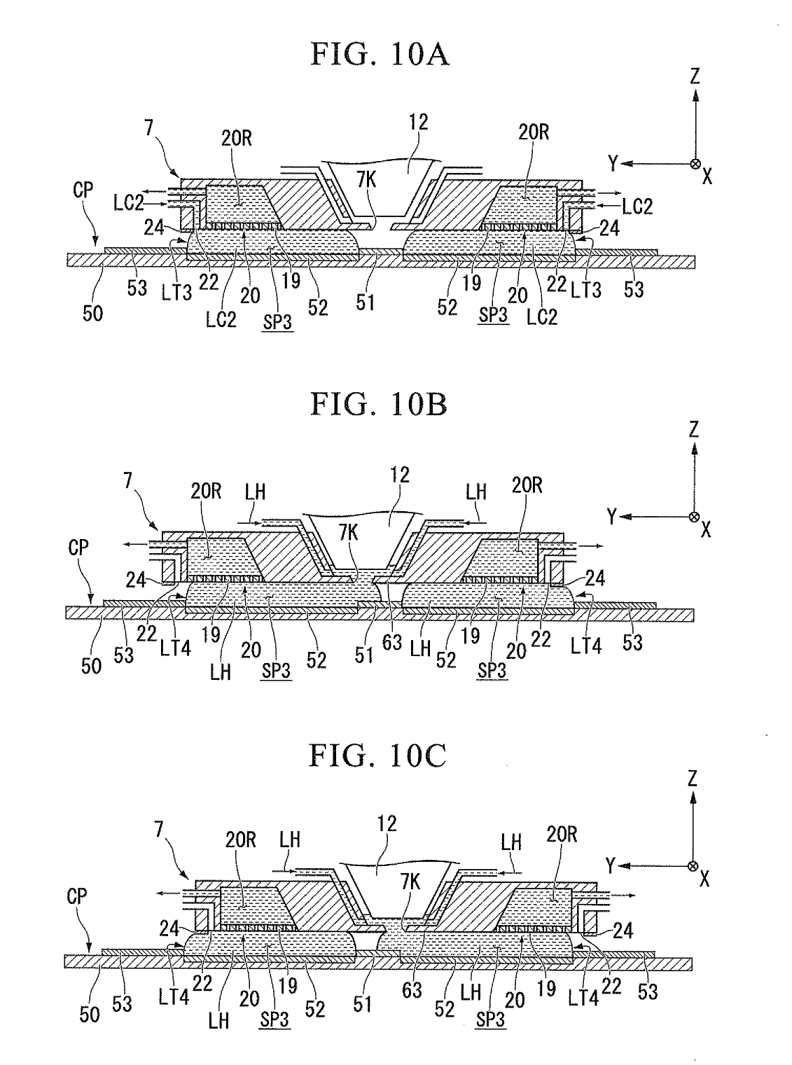

FIG. 10A is a diagram illustrating an example of a state where the second cleaning process is performed. In the second cleaning process, the supply of the second cleaning liquid LC2 through the second supply port 22 and the recovery of the second cleaning liquid LC2 through the liquid recovery port 20 are performed in parallel. In the present embodiment, in a similar way to the liquid immersion space LT1, a liquid immersion space LT3 is formed by the second cleaning liquid LC2 in at least a part of the space SP3 which is outside the opening 7K. In the present embodiment, the liquid immersion space LT3 is formed by the second cleaning liquid LC2 in at least a part of the space SP3 which is inside the second liquid-repellent portion 53. The second cleaning liquid LC2 is in contact with at least a part of the surface of the liquid immersion member 7 which includes the lower surface 14. The surface of the liquid immersion member 7 is cleaned by the second cleaning liquid LC2.

In the present embodiment, the dilution device 38 of the liquid system 100 shown in FIG. 4 dilutes the second cleaning liquid LC2 from the second cleaning liquid supply device 40 with the exposure liquid LQ. In the present embodiment, the second cleaning liquid LC2 transferred from the second cleaning liquid supply device 40 is an aqueous solution including hydrogen peroxide of a density of 30%. The dilution device 38 dilutes the second cleaning liquid LC2 with the exposure liquid (water) LQ, and generates an aqueous solution including hydrogen peroxide of a density of 5%. In the present embodiment, the aqueous solution including hydrogen peroxide of a density of 5% is supplied through the second supply port 22 as the second cleaning liquid LC2.

The density of the hydrogen peroxide included in the second cleaning liquid LC2 is not limited to the numerical value examples, and may be adjusted to a predetermined density suitable for cleaning. The density of the hydrogen peroxide included in the second cleaning liquid LC2 may not be 5%, but for example, may be 10% or more, 15% or more, or 20% or more. The density of the hydrogen peroxide included in the second cleaning liquid LC2 may be set according to resistance properties of a portion which may be in contact with the second cleaning liquid LC2. The portion which may be in contact with the second cleaning liquid LC2 may be one or more of members included in the liquid system 100 or the exposure apparatus EX. The portion which may be in contact with the second cleaning liquid LC2 may be at least a part of the cleaning substrate CP. As a liquid used for dilution of the second cleaning liquid LC2, a liquid (pure water) supplied from a supply device which is different from the supply source LQS may be used. Further, as a liquid used for dilution of the second cleaning liquid LC2, a liquid other than water may be used. The second cleaning liquid LC2 transferred from the second cleaning liquid supply device 40 may not be diluted. Further, the dilution device 38 may be omitted.

Further, in the second cleaning process, the static dipping process described in the first cleaning process may be performed using the second cleaning liquid LC2 instead of the first cleaning liquid LC1. Further, in the second cleaning process, using the same device or method used for applying vibration to the first cleaning liquid LC1, vibration may be applied to the second cleaning liquid LC2 between the liquid immersion member 7 and the cleaning substrate CP. Further, the second cleaning liquid LC2 to which vibration is applied may be supplied between the liquid immersion member 7 and the cleaning substrate CP.

The second cleaning liquid LC2 includes hydrogen peroxide and is capable of removing foreign substances which cannot be removed from the surface or the like of the liquid immersion member 7 by the first cleaning process. Further, the second cleaning liquid LC2 is capable of removing the first cleaning liquid LC1 which remains on the surface or the like of the liquid immersion member 7. For example, the second cleaning liquid LC2 is capable of removing the first cleaning liquid LC1 which cannot be removed from the surface of the liquid immersion member 7 by the rinse process. Accordingly, by supplying the second cleaning liquid LC2 to the liquid immersion member 7 for contact therewith, the foreign substances attached to the liquid immersion member 7 and the first cleaning liquid LC1 are removed.

The second cleaning liquid LC2 is capable of removing foreign substances which cannot be removed from the surface or the like of the liquid immersion member 7 by the first rinse process. In the present embodiment, the second cleaning liquid LC2 which is supplied to at least a part of the surface of the liquid immersion member 7 through the second supply port 22 is recovered through the liquid recovery port 20. The foreign substances or the like which are removed from the surface of the liquid ersion member 7 are recovered together with the second cleaning liquid LC2 through the liquid recovery port 20.

In the present embodiment, after the supply of the second cleaning liquid LC2 is stopped and the second cleaning liquid LC2 between the liquid immersion member 7 and the cleaning substrate CP is recovered at a predetermined timing, the first cleaning process is completed. The foreign substances which are removed from the surface of the liquid immersion member 7 are recovered together with the first cleaning liquid LC1 through the liquid recovery port 20. In the present embodiment, the second cleaning liquid LC2 which is recovered through the liquid recovery port 20 flows into the containing member 45.

The predetermined timing when the supply of the second cleaning liquid LC2 is stopped may be the time when the supply amount of the second cleaning liquid LC2 reaches a predetermined amount. The predetermined timing may be the time when the recovery amount through the liquid recovery port 20 reaches a predetermined amount. The predetermined timing may be the time when a period of time when the member which becomes a cleaning target is in contact with the second cleaning liquid LC2 reaches a predetermined time. The predetermined timing may be determined on the basis of the detection result of liquid components recovered through the liquid recovery port 20. The predetermined timing may be the time when the amount of removed substances through the cleaning is equal to or less than a predetermined value, which is included in the recovered second cleaning liquid LC2. The detection result may be the detection result of the detection device 42 of the liquid system 100.

In the present embodiment, after the supply of the second cleaning liquid LC2 through the second supply port 22 is stopped and the second cleaning process is completed, the second rinse process is started (step SA5). In the present embodiment, after the second cleaning liquid LC2 of the liquid immersion space LT2 is all recovered, the second rinse process is started. In a state where the supply of the second cleaning liquid LC2 through the second supply port 22 is stopped, the control device 8 performs the recovery of the second cleaning liquid LC2 for predetermined time through the liquid recovery port 20 (holes 19H of the porous member 19). Thus, the second cleaning liquid LC2 between the liquid immersion member 7 and the cleaning substrate CP is all recovered. The control device 8 starts the supply of the rinse liquid LH in order to rinse the liquid immersion member 7 with the rinse liquid LH.

In a state where the liquid immersion space LT2 of the second cleaning liquid LC2 is formed, the supply of the rinse liquid LH may be started. In order to recover approximately all the second cleaning liquid LC2, the second cleaning liquid LC2 may be recovered through the second supply port 22, in addition to the recovery operation through the liquid recovery port 20. Further, instead of the recovery operation through the liquid recovery port 20, the recovery operation through the second supply port 22 may be performed. Further, the second cleaning liquid LC2 may be recovered through the first supply port 21. After the supply of the second cleaning liquid LC2 is stopped, when the second rinse process is performed, the second cleaning liquid LC2 which remains in the second interior liquid passage 22R may be removed.

FIGS. 10B and 10C are diagrams illustrating an example of a state where the second rinse process is performed. In the second rinse process, the cleaning substrate CP is disposed to face the liquid immersion member 7. In the present embodiment, in a state where the relative positions of the opening 7K and the first liquid-repellent portion 51 are different compared with during the supply of the second cleaning liquid LC2 between the lyophilic portion 52 and the liquid immersion member 7, the rinse liquid LH is supplied between the liquid immersion member 7 and the lyophilic portion 52. In the present embodiment, after the second cleaning process is completed, the control device 8 adjusts the relative positions of the liquid immersion member 7 and the cleaning substrate CP. In the present embodiment, the relative positions of the liquid immersion member 7 and the cleaning substrate CP are adjusted so that at least a part of the opening 7K when seen from a planar view is disposed outside of the first liquid-repellent portion 51. In the present embodiment, the relative positions of the liquid immersion member 7 and the cleaning substrate CP are adjusted so that at least a part of the opening 7K faces the lyophilic portion 52. In the present embodiment, in a state where the supply of the cleaning liquid LC through the second supply port 22 is stopped, the control device 8 supplies the rinse liquid LH to the space SP1 through the first supply port 21. In the present embodiment, the exposure liquid LQ is used as the rinse liquid LH.

In the second rinse process, the supply of the rinse liquid LH (exposure liquid LQ) through the first supply port 21 and the recovery of the liquid (including at least one of the first cleaning liquid LC1 and the rinse liquid LH) through the liquid recovery member 20 are performed in parallel. Thus, a liquid immersion space LT4 is formed by the rinse liquid LH between the terminal optical device 12 and the liquid immersion member 7, and the cleaning substrate CP. The surface of the liquid immersion member 7 is rinsed by the rinse liquid LH. The rinse liquid LH is capable of removing the second cleaning liquid LC2 which remains on the surface of the liquid immersion member 7. The rinse liquid LH is capable of removing foreign substances attached to the liquid immersion member 7. The liquid recovery port 20 recovers the rinse liquid LH which is supplied to at least a part of the surface of the liquid immersion member 7 through the first supply port 21. The second cleaning liquid LC2 which is removed from the surface of the liquid immersion member 7 is recovered together with the rinse liquid LH through the liquid recovery port 20. In the present embodiment, the recovered rinse liquid LH flows into the containing member 45.

As shown in FIG. 10C, in the present embodiment, in a similar way to the first rinse process, in the second rinse process, the rinse liquid LH is supplied even in a state where the relative positions of the liquid immersion member 7 and the cleaning substrate CP are changed compared with the supply starting time of the rinse liquid LH. In the present embodiment, the relative positions of the liquid immersion member 7 and the cleaning substrate CP are changed in a direction which is parallel to the XY plane. In the present embodiment, the relative positions of the liquid immersion member 7 and the cleaning substrate CP are changed so that a portion 63 (see FIG. 10B) of the liquid immersion member 7 which has faced the first liquid-repellent portion 51 at the supply starting time of the rinse liquid LH faces the lyophilic portion 52. In the present embodiment, in a state where the portion 63 faces the lyophilic portion 52, the rinse liquid LH is supplied. In the present embodiment, the supply of the rinse liquid LH is stopped before change in the relative positions of the liquid immersion member 7 and the cleaning substrate CP, and the supply of the rinse liquid LH is restarted after the change.

The rinse liquid LH may be supplied while the relative positions of the liquid immersion member 7 and the cleaning substrate CP are changed. In a state where the relative positions in the Z axis direction of the liquid immersion member 7 and the cleaning substrate CP are different compared with the time when the first cleaning liquid LC1 is supplied between the lyophilic portion 52 of the cleaning substrate CP and the liquid immersion member 7, the rinse liquid LH may be supplied. In a state where the interval between the liquid immersion member 7 and the cleaning substrate CP are broad compared with during the supply of the second cleaning liquid LC2 between the lyophilic portion 52 and the liquid immersion member 7, the rinse liquid LH may be supplied. Further, vibration may be applied to the rinse liquid LH between the liquid immersion member 7 and the cleaning substrate CP. Using the same device or method used for applying vibration to the first cleaning liquid LC1, vibration may be applied to the rinse liquid LH in the second rinse process. In the second rinse process, the rinse liquid LH may be supplied through the second supply port 22. The rinse liquid LH may be supplied through the first supply port 21 and the second supply port 22. Vibration is applied to the rinse liquid LH between the liquid immersion member 7 and the cleaning substrate CP, but instead, the rinse liquid LH to which vibration is applied may be supplied between the liquid immersion member 7 and the cleaning substrate CP.

In the present embodiment, the supply of the rinse liquid LH is stopped at a predetermined timing, and then the second rinse process is completed. The predetermined timing when the supply of the rinse liquid LH is stopped may be the time when the supply amount of the rinse liquid LH reaches a predetermined amount. The predetermined timing may be the time when the recovery amount through the liquid recovery port 20 reaches a predetermined amount. The predetermined timing may be the time when a period of time when the member which becomes a cleaning target is in contact with the rinse liquid LH reaches a predetermined time. The predetermined timing may be determined on the basis of the detection result of liquid components recovered through the liquid recovery port 20. The predetermined timing may be the time when the amount of the second cleaning liquid LC2 (density) included in the recovered liquid is equal to or less than a predetermined value. Until the density of the hydrogen peroxide included in the rinse liquid LH which is recovered through the liquid recovery port 20 reaches 1% or less, the second rinse process may be continued. The detection result may be the detection result of the detection device 42 of the liquid system 100.

In the present embodiment, after the second rinse process, the third rinse process is performed (step SA6). In the present embodiment, the rinse liquid LH which is recovered through the liquid recovery port 20 is contained in the containing member 45 until the density of the second cleaning liquid LC2 included in the rinse liquid LH is equal to or less than a predetermined density. In the present embodiment, after the density of the second cleaning liquid LC2 included in the rinse liquid LH is equal to or less than the predetermined density, the control device 8 controls the liquid system 100 so that the rinse liquid LH which is recovered through the liquid recovery port 20 flows into the containing member 43, while performing the supply of the rinse liquid LH through the first supply port 21 and the recovery of the rinse liquid LH through the liquid recovery port 20 in parallel.

After the third rinse process is completed, the control device 8 performs a process of unloading the cleaning substrate CP from the substrate stage 2 (step SA7). The control device 8 moves the second substrate stage 2 to the substrate exchange position in order to unload the cleaning substrate CP from the substrate stage 2 (substrate holding section 11). After the cleaning substrate CP is unloaded from the substrate stage 2, the control device 8 may perform the exposure sequence including the exposure process of the substrate P.

Instead of the cleaning substrate CP, a stage including a liquid-repellent portion and a lyophilic portion like the cleaning substrate CP, for example, a substrate stage, a measurement stage, or a stage for maintenance other than these stages may be used.

In the cleaning method, at least one of the first cleaning process and the second cleaning process may be omitted. Further, the first, second and third rinse processes may be omitted. For example, the first rinse process after the first cleaning process may be omitted.

In the cleaning method, the supply of the cleaning liquid LC is not limited to the supply through the second supply port 22. For example, the cleaning liquid LC may be supplied through the liquid recovery port 20 or may be supplied through the first supply port 21. For example, the liquid (the cleaning liquid LC, the rinse liquid LQ or the like) may be supplied through the liquid recovery port 20 (the holes 19H), and the liquid which is supplied through the liquid recovery port 20 may be recovered through the second supply port 22 which is disposed outside the liquid recovery port 20. Further, the cleaning liquid LC which is supplied through the second liquid supply port 22 may be recovered through the liquid recovery port 20, and the rinse liquid LQ which is supplied through the liquid recovery port 20 may be recovered through the second supply port 22, or contrarily, the cleaning liquid LC which is supplied through the liquid recovery port 20 may be recovered through the second liquid supply port 22, and the rinse liquid LQ which is supplied through the second supply port 22 may be recovered through the liquid recovery port 20.

### Fourth Embodiment

A fourth embodiment will now be described. In the present embodiment, the same component parts as in the above embodiments are assigned identical symbols, and descriptions thereof may be omitted.

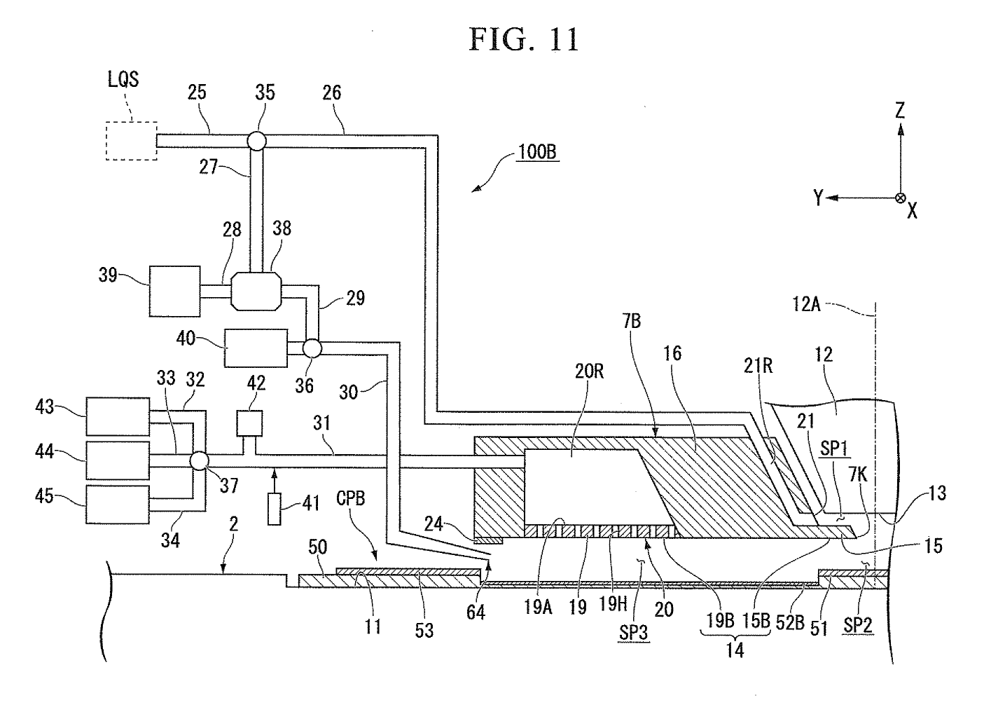

FIG. 11 is a diagram illustrating an example of a cleaning method according to the present embodiment. In the present embodiment, a cleaning substrate CPB which is an example of the cleaning substrate is used. In the present embodiment, a lyophilic portion 5213 of the cleaning substrate CPB includes a bottom portion of a concave portion disposed in the substrate main body 50. In the cleaning method according to the present embodiment, the liquid immersion member includes the opening 7K through which exposure light passes and the liquid recovery port 20 which is disposed in at least a part of the periphery of the opening 7K.

In the cleaning method according to the present embodiment, a liquid system 100B which supplies a cleaning liquid is used. The liquid system 100B includes a supply port 64 through which the first cleaning liquid LC1 can be supplied. In the present embodiment, the supply port 64 is a member different from a liquid immersion member 7B. A member having the supply port 64 is supported by a member (not shown) different from a liquid immersion member 7B. In the present embodiment, the first cleaning liquid LC1 is supplied between the cleaning substrate CPB and the liquid immersion member 7b through the supply port 64. The liquid system 100B according to the present embodiment can supply a liquid selected from the exposure liquid LQ, the first cleaning liquid LC1 (including diluted liquid), the second cleaning liquid (including diluted liquid) and a mixed liquid of the first cleaning liquid LC1 and the second cleaning liquid LC2 through the supply port 64.

The cleaning method according to the present embodiment includes the same steps SA1 to SA6 as in the third embodiment. In the present embodiment, by operating a drive device (not shown), it is possible to drive the supply port 64 and to change the position. In the present embodiment, the supply port 64 is inserted between the liquid immersion member 713 and the cleaning substrate CPB. Further, each liquid used for cleaning is supplied between the lyophilic portion 52B and the liquid immersion member 7B through the supply port 64. In the present embodiment, in a similar way to the third embodiment, the liquid immersion space LT1 is formed by the first cleaning liquid LC1 in at least a part of the space SP3 which is outside the opening 7K, and the liquid immersion space LT1 is formed by the first cleaning liquid LC1 in at least a part of the space SP3 which is inside the second liquid-repellent portion 53. Further, in the present embodiment, in a similar way to the third embodiment, the liquid immersion space LT3 is formed by the second cleaning liquid LC2 in at least a part of the space SP3 which is outside the opening 7K, and the liquid immersion space LT3 is formed by the second cleaning liquid LC2 in at least a part of the space SP3 which is inside the second liquid-repellent portion 53. In the present embodiment, the supply port 64 is driven, but may not be driven. Each liquid used for cleaning may be supplied through the supply port 64 in a state where the supply port 64 faces the lyophilic portion 52B. Further, each liquid used for cleaning may be supplied through the supply port 64 in a state where the supply port 64 faces the second liquid-repellent portion 53.

### Fifth Embodiment

A fifth embodiment will now be described. In the present embodiment, the same component parts as in the above embodiments are assigned identical symbols, and descriptions thereof may be omitted.

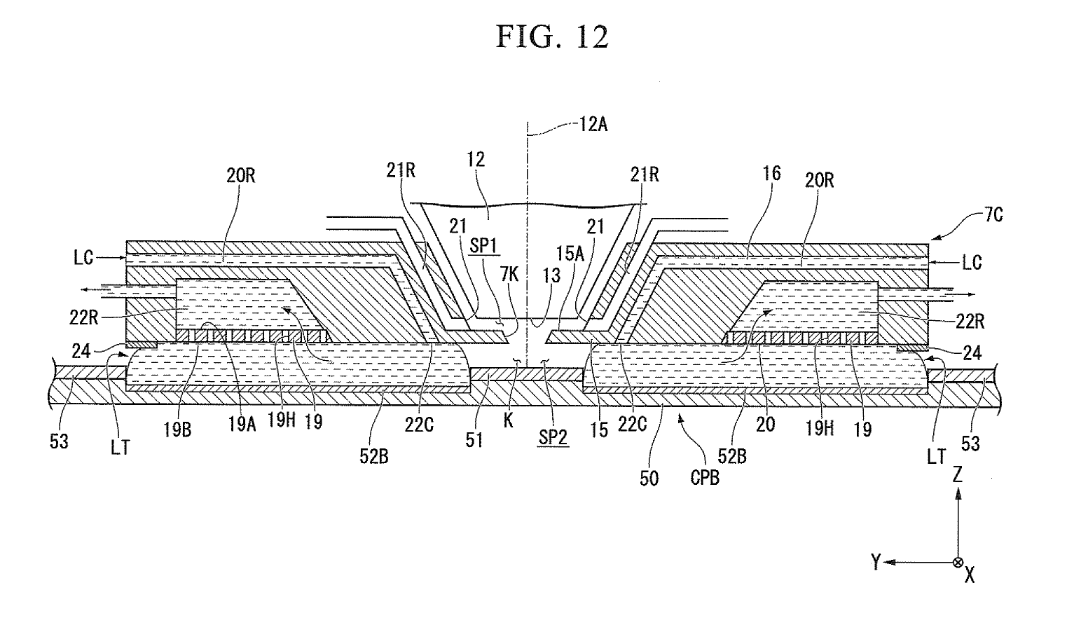

FIG. 12 is a diagram illustrating an example of a cleaning method according to the present embodiment. In the present embodiment, a cleaning substrate CPB which is an example of the cleaning substrate is used. In the cleaning method according to the present embodiment, a liquid immersion member 7C which includes an opening 7K through which exposure light passes, a supply port 22C which is disposed in at least a part of the periphery of the opening 7K and through which a liquid for cleaning is supplied, and a liquid recovery port 20 which is disposed outside the supply port 20 with reference to the opening 7K.

The cleaning method according to the present embodiment includes the same steps SA1 to SA6 as in the third embodiment. In the present embodiment, in a similar way to the third embodiment, the liquid immersion space LT is formed by the cleaning liquid LC in at least a part of the space SP3 which is outside the opening 7K, and the liquid immersion space LT is formed by the cleaning liquid LC in at least a part of the space SP3 which is inside the second liquid-repellent portion 53.

### Sixth Embodiment

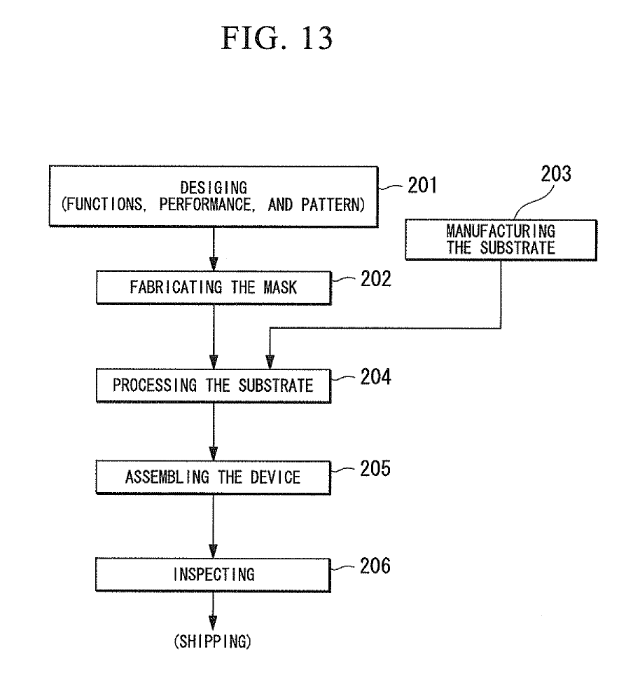

FIG. 13 is a flowchart illustrating an example of a device manufacturing method. A microdevice such as a semiconductor device is manufactured through a step 201 in which the functions and performance of the microdevice are designed; a step 202 in which a mask (reticle) is fabricated on the basis of the above designing step; a step 203 in which a substrate which is a base material of the device is manufactured; a substrate processing step 204 which includes a substrate treatment (exposure process) which includes exposing the substrate with the exposure light passing through the pattern of the mask and developing the exposed substrate, in accordance with the above-described embodiments; a device assembling step 205 (which includes fabrication processes such as dicing, bonding, and packaging); an inspecting step 206; and the like. The substrate processing step includes a process of cleaning the liquid immersion member 7 or the like according to the above-described embodiments, and the substrate P is exposed with the exposure light EL using the cleaned liquid immersion member 7 or the like.

For example, as disclosed in International Publication No. 2004/019128, it is possible to employ the projection optical system PL in which the optical path of an incident side (a surface side of an object) of the terminal optical device 12 is also filled with the exposure liquid LQ.

In each of the above-described embodiments, water is used as the exposure liquid LQ, but liquid other than water may be used. It is preferable to use an exposure liquid which is capable of transmitting the exposure light EL, has a high refraction index to the exposure light EL and is stable to a film such as a photosensitive member (photoresist) which forms the surfaces of the projection optical system PL or the substrate P, as the exposure liquid LQ. For example, hydrofluoroether (HFE), perfluoropolyether (PFPE), Fomblin oil or the like may be used as the first liquid (exposure liquid LQ). Further, a variety of fluids, for example, a supercritical fluid may be used as the first liquid.

As the substrate P according to the above-described each embodiment, in addition to a semiconductor wafer for semiconductor device manufacturing, a glass substrate for a display device, a ceramic wafer for a thin film magnetic head, an original plate (synthetic quarts, silicon wafer) of a mask or a reticle used in an exposure apparatus, or the like may be employed.

As the exposure apparatus EX, in addition to a step and scan type scanning exposure apparatus (scanning stepper) in which the mask M and the substrate P are synchronously moved to perform scanning-exposure of the pattern of the mask M, a step and repeat type projection exposure apparatus (stepper) in which the pattern of the mask M are collectively exposed in a state where the mask M and the substrate P are still and the substrate P is moved in a sequential step manner may be applied. Further, in the step and repeat type exposure, in a state where a first pattern and the substrate P are approximately still, a reduced image of the first pattern may be transferred onto the substrate P using the projection optical system, and thereafter, in a state where a second pattern and the substrate P are approximately still, a reduced image of the second pattern may be partially overlapped with the first pattern using the projection optical system to then be collectively exposed on the substrate P (one-shot exposure apparatus of a stitch type). Further, as the stitch type exposure apparatus, a step and stitch type exposure apparatus in which at least two patterns are overlapped and transferred onto the substrate P and the substrate P is moved in a sequential manner may be employed.

Further, for example, as disclosed in U.S. Pat. No. 6,611,316, the present invention may be applied to an exposure apparatus in which patterns of two masks are synthesized on a substrate through a projection optical system, and one shot region on the substrate is doubly exposed approximately at the same time by one scanning exposure. Further, the present invention may be applied to a proximity type exposure apparatus, a mirror projection aligner or the like.

The exposure apparatus EX may be an exposure apparatus which does not include the measurement stage 3. Further, the present invention may be applied to an exposure apparatus which includes a plurality of substrate stages and measurement stages. The exposure apparatus EX may be a twin stage type exposure apparatus which does not include a measurement stage and includes a plurality of substrate stages, as disclosed in U.S. Pat. No. 6,341,007, U.S. Pat. No. 6,208,407, U.S. Pat. No. 6,262,796 or the like. In this case, a cleaning sequence may be performed by allowing an arbitrary substrate stage among the plurality of substrate stages to face the immersion member 7.

The type of the exposure apparatus EX is not limited to an exposure apparatus for manufacturing a semiconductor device which exposes a semiconductor device pattern on the substrate P, and the present invention may be widely applied to an exposure apparatus for manufacturing a liquid crystal display device or a display, an exposure apparatus for manufacturing a thin film magnetic head, a charge-coupled device (CCD), a micromachine, a MEMS, a DNA chip, a reticle, a mask or the like.

In the above-described embodiments, position information about each stage is measured using an interferometer system which includes a laser interferometer, but the present invention is not limited thereto. For example, an encoder system which detects a scale (diffraction grating) disposed in each stage may be used.

In the above-described embodiments, a light transmitting mask in which a predetermined light shield pattern (or phase pattern and light reduction pattern) is formed on a light transmitting substrate is used, but instead, for example, as disclosed in U.S. Pat. No. 6,778,257, a variable shaped mask (also referred to as an electronic mask, an active mask or an image generator) which forms a transmitting pattern, a reflecting pattern or a light emitting pattern may be used on the basis of electronic data of a pattern to be exposed. Further, instead of the variable shaped mask which includes a non-light emitting image display device, a pattern forming apparatus which includes a light-emitting image display device may be used.

In the above-described embodiments, the exposure apparatus which includes the projection optical system PL is described as an example, but the present invention may be applied to an exposure apparatus which does not use the projection optical system PL and an exposure method thereof. For example, a liquid immersion space may be formed between an optical member such as a lens and a substrate, and the substrate may be irradiated with exposure light through the optical member. Further, for example, as disclosed in International Publication No. 2001/035168, it is possible to apply the present invention to an exposure apparatus (lithography system) which exposes a line and space pattern on the substrate P by forming interference fringes on the substrate P.

The exposure apparatus EX according to the above-described embodiments is manufactured by assembling a variety of subsystems including the respective components while maintaining a predetermined level of mechanical, electrical and optical accuracy. To achieve the variety of accuracy levels, before and after the assembly, adjustment for achieving the optical accuracy is performed in a variety of optical systems, adjustment for achieving the mechanical accuracy is performed in a variety of mechanical systems, and adjustment for achieving the electrical accuracy is performed in a variety of electrical systems. The assembly process of the variety of subsystems into the exposure apparatus includes mechanical connection, wiring connection of electric circuits, piping connection of pneumatic circuits, or the like, between the respective subsystems. Before the assembly process of the variety of subsystems into the exposure apparatus, an individual assembly process of each subsystem is performed. After the assembly process of the variety of subsystems into the exposure apparatus is completed, final adjustment is performed to achieve the variety of accuracies of the entire exposure apparatus. It is preferable that the manufacture of the exposure apparatus be performed in a clean room in which the temperature and cleaning level thereof are managed.

The conditions of the above-described embodiments may be appropriately combined. Further, a part of the components may not be used. Further, as long as laws and regulations permit, all the disclosures of the publications and U.S. patents relating to exposure apparatuses or the like, which are referenced in the above-described embodiments and modifications, are incorporated as a part of this description.

1. A method of cleaning a liquid immersion member that has an opening through which exposure light irradiating a substrate passes and that holds a first liquid between the liquid immersion member and the substrate so that at least a part of an optical path of the exposure light is filled with the first liquid, in a liquid immersion exposure apparatus, the method comprising:
allowing an object, which has a first portion which is liquid-repellent to a second liquid for cleaning and a second portion which is disposed in at least a part of the periphery of the first portion and is more lyophilic than the first portion, and the liquid immersion member to face each other;
supplying the second liquid between the liquid immersion member and the second portion of the object; and
cleaning the liquid immersion member with the second liquid while suppressing the second liquid supplied between the liquid immersion member and the second portion from passing through the opening by use of the first portion of the object.

2. The cleaning method according to claim 1,
wherein the second portion is disposed to surround the first portion, and
wherein the object has a third portion that is more liquid-repellent to the second liquid than the second portion and surrounds the second portion.

3. The cleaning method according to claim 2,
wherein the liquid immersion member has a liquid-repellent portion that is liquid-repellent to the second liquid, and
wherein the liquid immersion member and the object face each other so that the third portion of the object faces the liquid-repellent portion of the liquid immersion member.

4. The cleaning method according to claim 1,
wherein the liquid immersion member has a surface that faces the object around the opening, and
wherein the object and the liquid immersion member face each other so that at least a part of the first portion of the object faces the surface.

5. The cleaning method according to claim 4,
wherein the object and the liquid immersion member face each other so that an annular outer periphery of the first portion faces the surface around the opening.

6. The cleaning method according to claim 5, further comprising: moving the liquid immersion member and the object relatively in a state where the annular outer periphery of the first portion faces the surface around the opening.

7. The cleaning method according to claim 5,
wherein a region surrounded by the annular outer periphery of the first portion is larger than the opening.

8. The cleaning method according to claim 7,
wherein the first portion in the object has an annular shape.

9. The cleaning method according to claim 4,
wherein the liquid immersion member has a liquid recovery port that is disposed in at least a part of the periphery of the surface.

10. The cleaning method according to claim 1,
wherein the second liquid supplied between the liquid immersion member and the second portion is recovered.

11. The cleaning method according to claim 10,
wherein the liquid immersion member has a liquid recovery port that is disposed in at least a part of the periphery of the opening, and
wherein the second liquid supplied between the liquid immersion member and the second portion is recovered through the liquid recovery port.

12. The cleaning method according to claim 11,
wherein the second liquid is recovered in parallel with the supply of the second liquid.

13. The cleaning method according to claim 11,
wherein the second liquid is supplied through a supply port that is disposed outside of the liquid recovery port with reference to the opening.

14. The cleaning method according to claim 13, further comprising:
supplying a third liquid that is different from the second liquid between the liquid immersion member and the second portion through the supply port, after recovering the second liquid from between the liquid immersion member and the second portion.

15. The cleaning method according to claim 1, further comprising:
supplying a third liquid that is different from the second liquid between the liquid immersion member and the second portion.

16. The cleaning method according to claim 15,
wherein the third liquid is supplied after the liquid is removed from between the liquid immersion member and the object.

17. The cleaning method according to claim 14,
wherein the third liquid is supplied between the liquid immersion member and the second portion through the opening.

18. The cleaning method according to claim 15,
wherein relative positions of the opening and the first portion are different, between when the third liquid is supplied between the liquid immersion member and the second portion and when the second liquid is supplied between the liquid immersion member and the second portion.

19. The cleaning method according to claim 18,
wherein the liquid immersion exposure apparatus has a projection optical system that emits the exposure light, and
wherein the relative positions of the opening and the first portion become different in a direction which intersects with an optical axis of the projection optical system.

20. The cleaning method according to claim 18,
wherein the liquid immersion exposure apparatus comprises a projection optical system that emits the exposure light, and
wherein the relative positions of the opening and the first portion are different in a direction which is in parallel with an optical axis of the projection optical system.

21. The cleaning method according to claim 14,
wherein the first liquid is used as the third liquid.

22. The cleaning method according to claim 14, further comprising:
applying vibration to the third liquid.

23. The cleaning method according to claim 1,
wherein the object is a cleaning substrate that is used for cleaning of the liquid immersion member.

24. The cleaning method according to claim 1, further comprising:
applying vibration to the second liquid.

25. The cleaning method according to claim 1,
wherein the object faces the liquid immersion member without contact.

26. The cleaning method according to claim 1,
wherein a gap between the liquid immersion member and the first portion is smaller than a gap between the liquid immersion member and the second portion, when the liquid immersion member and the object face each other.

27. The cleaning method according to claim 1,
wherein the liquid immersion member and the object face each other so that at least a part of the first portion faces the opening.

28. A device manufacturing method comprising:
cleaning the liquid immersion member using the method according to claim 1;
holding the first liquid between the cleaned liquid immersion member and a substrate;
exposing the substrate with exposure light through the first liquid; and
developing the exposed substrate.

29. A cleaning substrate that is used for cleaning a liquid immersion member which has an opening through which exposure light irradiating a substrate passes and a liquid recovery port which is disposed in at least a part of the periphery of the opening, and holds a first liquid between the liquid immersion member and the substrate so that at least a part of an optical path of the exposure light is filled with the first liquid, in a liquid immersion exposure apparatus, the cleaning substrate comprising:
a first portion which is liquid-repellent to a second liquid for cleaning; and
a second portion which is disposed in at least a part of the periphery of the first portion and is more lyophilic to the second liquid than the first portion,
wherein when the cleaning substrate is disposed to face the liquid immersion member so as to clean the liquid immersion member with the second liquid, the first portion suppresses the second liquid supplied between the liquid immersion member and the second portion from passing through the opening.

30. The cleaning substrate according to claim 29,
wherein a region inside an annular outer periphery of the first portion is larger than the opening.

31. The cleaning substrate according to claim 29,
wherein the second portion is disposed to surround the first portion, and
wherein the object has a third portion that is more liquid-repellent to the second liquid than the second portion and surrounds the second portion.

32. The cleaning substrate according to claim 31,
wherein the third portion is more protruded than the second portion.

33. The cleaning substrate according to claim 30,
wherein the first portion has an annular shape.

34. The cleaning substrate according to claim 33, further comprising a fourth portion that is surrounded by the first portion and is more lyophilic to the second liquid than the first portion.

35. The cleaning substrate according to claim 29,
wherein the first portion is more protruded than the second portion.

36. The cleaning substrate according to claim 29, further comprising:
a notch associated with an operation of cleaning the liquid immersion member with the second liquid.

37. A liquid immersion member that is used in a liquid immersion exposure apparatus which exposes a substrate with exposure light through a first liquid, and holds the first liquid between the liquid immersion member and the substrate so that at least a part of an optical path of the exposure light is filled with the first liquid, the liquid immersion member comprising:
an opening through which the exposure light passes;
a liquid recovery port which is disposed in at least a part of the periphery of the opening; and
a supply port which is disposed outside of the liquid recovery port with reference to the opening and through which a second liquid for cleaning is supplied.

38. The liquid immersion member according to claim 37, further comprising:
a liquid-repellent section that is disposed outside the supply port with reference to the opening and is liquid-repellent to the second liquid.

39. The liquid immersion member according to claim 38,
wherein the liquid-repellent section surrounds the supply port in an annular shape.

40. The liquid immersion member according to claim 38,
wherein the supply port supplies the second liquid to the inside of the liquid-repellent section.

41. A liquid immersion exposure apparatus that exposes a substrate with exposure light through a first liquid, the apparatus comprising the liquid immersion member according to claim 37.

42. A device manufacturing method comprising:
exposing a substrate using the liquid immersion exposure apparatus according to claim 41; and
developing the exposed substrate.

43. A dummy substrate that is used for a non-exposure operation of a liquid immersion exposure apparatus which exposes a substrate with exposure light through a liquid, which is different from an exposure operation of exposing the substrate, the dummy substrate comprising a notch associated with the non-exposure operation in an outer periphery portion thereof.

44. The dummy substrate according to claim 43,
wherein at least one of a number of the notch, a shape of the notch and a position of the notch in the outer periphery portion is determined in association with the non-exposure operation.

45. The dummy substrate according to claim 43, further comprising:
a lyophilic portion that is lyophilic to a predetermined liquid and a liquid-repellent portion that is liquid-repellent to the liquid,
wherein at least one of a distribution of the lyophilic portion and the liquid-repellent portion, a contact angle of the lyophilic portion with respect to the liquid and a contact angle of the liquid-repellent portion with respect to the liquid is set in association with the non-exposure operation.
